(19) United States
(12) Patent Application Publication
(10) Pub. No.: US 2010/0068299 A1
(43) Pub. Date: Mar. 18, 2010

(54) LIGNOSULFONATE COMPOSITIONS FOR CONTROL OF PLANT PATHOGENS

(76) Inventors: Wilhelmus Maria van der Krieken, Wageningen (NL); Cornelis Johannes Kok, Elst (NL); Lucas Henricus Stevens, Utrecht (NL); Evert Davelarr, Veenendaal (NL)

Correspondence Address: AGRAQUEST, INC., 1540 DREW AVENUE, DAVIS, CA, 95618, US

(21) Appl. No.: 12/496,492

(22) Filed: Jul. 1, 2009

Related U.S. Application Data
(63) Continuation-in-part of application No. PCT/NL2008/050796, filed on Dec. 12, 2008.
Application No. PCT/NL2008/050796 is a continuation-in-part of application No. 10/543,702, filed on Apr. 17, 2006.

(30) Foreign Application Priority Data
Jan. 27, 2003 (EP) PCT/EP03/00840

(51) Int. Cl. A01N 59/20; A01N 61/00; A01P 1/00

(52) U.S. Cl. 424/638; 514/22

(57) ABSTRACT

The present invention relates to a composition comprising a soluble combination comprising lignosulfonate, a metal salt, and a phosphorus compound selected from the group consisting of phosphorus acid and spontaneously soluble salts thereof, and mixtures thereof. The present invention also relates to the use of such compositions as pesticides.

### CROSS-REFERENCE TO RELATED APPLICATIONS

The present application claims priority to and is a Continuation-In-Part of International Patent Application No. PCT/NL2008/050796 filed Dec. 12, 2008, which claims priority to European Patent Application No. 2007123860.4 filed on Dec. 20, 2007, and this application also claims priority to U.S. patent application Ser. No. 10/543,702, which in turn claims priority as a National Stage Entry of International Patent Application No. PCT/EP2004/000742, filed Jan. 27, 2004, which in turn claims priority to International Patent Application No. PCT/EP2003/000840, filed Jan. 27, 2003. Each of the foregoing applications is hereby incorporated by reference in its entirety.

### TECHNICAL FIELD

This invention relates to the technical field of formulation technology of plant protection agents and and/or plant fertilizing agents and to methods of preparing and using such formulations.

### BACKGROUND

Agricultural production worldwide is under permanent threat from numerous phytopathogenic fungi and bacteria. For the protection of yield and quality of products and to avoid economic losses, the application of chemical agents that control plant diseases are an absolute requirement. Although the need for pesticides is generally acknowledged, there is an ongoing public concern about the possible negative impact of pesticides on the environment and on human health. As a consequence, the demands with respect to sustainability of chemical pest control are continually increasing, as are the costs to bring new pesticides to the market.

EP A 249.566 discloses bactericide compositions comprising a metal salt of a phosphorus acid monoester, said bactericide compositions being used for treating plants suffering from bactericidal diseases. Examples C, E and H disclose such a bactericide composition in powder form which further contains calcium or sodium lignosulfonate and optionally a metal salt, e.g. calcium carbonate.

U.S. Pat. No. 4,139,616 discloses compositions for controlling fungus diseases which contain as active material a metal salt of a phosphorus acid monoester. Examples 1 and 2 disclose such compositions as wettable powders which further contain 5% calcium lignosulfate.

U.S. Pat. No. 6,689,392 discloses compositions for controlling plant pathogens comprising an effective amount of a metal ion, a chelating agent, and phosphorus acid, and/or salt or hydrate thereof, which further contain from about 1% to 10% of an acidifying agent such as lignosulfonate.

The present invention meets a long felt need for improved compositions for preventing and/or treating plant pathogens, wherein such compositions contain metal as an active compound.

### SUMMARY

The present invention provides formulation technologies for soluble compositions of plant protecting agents and/or plant fertilizing agents and to methods which substantially or completely prevent the formation of metal phosphite precipitates from phosphorus compounds and metal salts that are dissolved in aqueous solvents before and during their combined application. The compositions of the present invention are useful in the control of plant pathogens, i.e. as a fungicide or as a bactericide, and as a plant fertilizer.

The present invention provides compositions of plant protecting agents and/or plant fertilizing agents and methods which substantially prevent the formation of copper or metal phosphite precipitates from phosphorus acid, and/or a salt and/or a hydrate and/or an ester thereof and metal salts that are dissolved in aqueous solvents before and during their combined application. Hence, the methods ensure that after application, the active ingredients remain relatively immobile over the long term.

The present invention provides a composition comprising at least one soluble combination comprising at least one lignosulfonate, at least one metal salt, and at least one phosphorus compound, wherein the composition excludes a solubilizing amount of a chelator. In one embodiment, the composition is in liquid form. In one embodiment, the composition is a solution. In other embodiments, the composition is a water soluble powder or a water soluble granule. In one embodiment, the soluble composition further comprises at least one compound as to form a composition with a pH within a range from about 4.8 to about 5.8. Alternatively, the composition further comprises a buffer salt with a pH within a range from about 4.8 to about 5.8.

The present invention also provides methods of preventing formation of a metal phosphite precipitate in an aqueous solvent.

The present invention also relates to methods for preparing an aqueous composition comprising at least one metal compound, at least one lignosulfonate and at least one phosphorus compound.

The present invention further provides methods for controlling plant pathogens. In one embodiment, the present invention provides a method for controlling plant pathogens by using said composition as a fungicide. In one embodiment, the present invention provides a method for controlling plant pathogens by using said composition as a bactericide.

The present invention further provides methods of using said composition as a fertilizer.

### BRIEF DESCRIPTION OF THE DRAWINGS

FIG. 1 represents DuPont™ KOCIDE® 2000 fungicide/bactericide and Composition 4. As it shows, KOCIDE® 2000 is a suspension of wettable powder, while Composition 4 is a solution of water soluble powder.

FIG. 2 represents results of controlling late blight (Phytophthora infestans) on tomato in the greenhouse by Composition 4 (C. 4) and DuPont™ KOCIDE® 2000 fungicide/bactericide.

FIG. 3 represents results of controlling downy mildew (Pseudoperonospora cubensis) on cucumber in the greenhouse by Composition 4 (C. 4) and DuPont™ KOCIDE® 2000 fungicide/bactericide.

FIG. 4 represents cucumber plants sprayed with Composition 4 and DuPont™ KOCIDE® 2000 fungicide/bactericide. Picture was taken six days after downy mildew infection.

FIG. 5 represents results of controlling tomato speck (Pseudomonas syringae) on cucumber in the greenhouse by Composition 4 (C. 4) and DuPont™ KOCIDE® 2000 fungicide/bactericide.

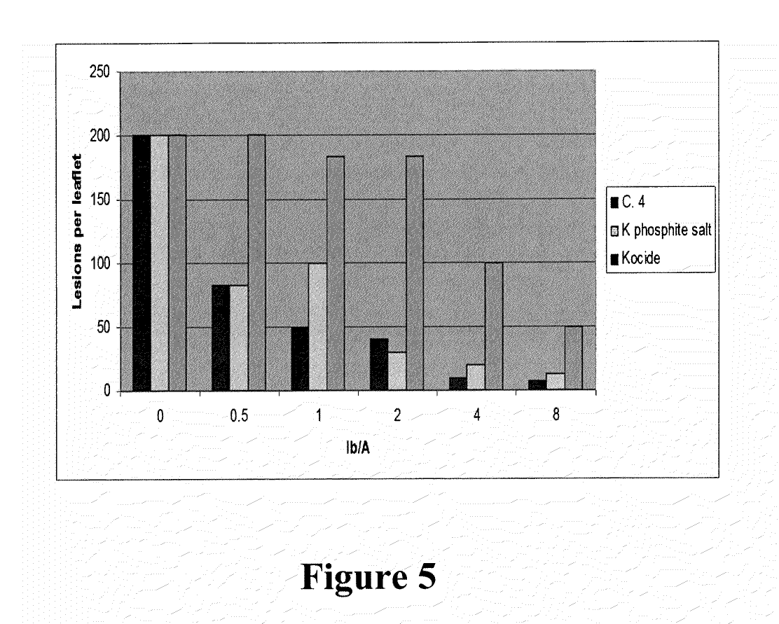

### DETAILED DESCRIPTION

All publications, patents and patent applications, including any claims, drawings and appendices, herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

### Definitions

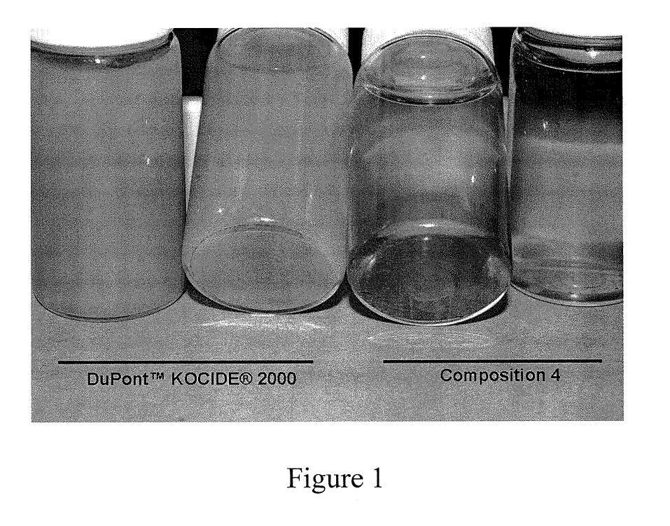

As used herein, the term “soluble” refers to the ability of a substance, a solute, to dissolve in a solvent, i.e. a liquid (e.g., water), without forming a visually noticeable or measurable precipitate. In contrast, a suspension may contain a very fine dispersion of particles of a solid material, but these particles do not dissolve in the solvent. Typically, solutions are translucent or clear while suspensions are milky or opaque and particles may settle out over time, as shown in FIG. 1. As another example, table salt (NaCl) is soluble in water but gypsum (calcium sulphate) is largely insoluble in water.

As used herein, the term “spontaneously soluble” refers to a solution that is soluble at a certain pH without the addition of a chelating or complexing agent. Those skilled in the art sometimes refer to “spontaneously soluble” as “naturally soluble” and we use those terms interchangeably herein unless specified otherwise.

As used herein, the term “solubility” refers to a measurement of how much solute can dissolve in a liquid (e.g., water). Solubility may be expressed as a ratio of solute to solvent volume or may be described qualitatively using words such as insoluble, very soluble or miscible.

As used herein, the phrase “water soluble granules” refers to a preparation consisting of granules to be applied as a true solution of active substance after dissolution in water but that may contain insoluble inert ingredients.

As used herein, the phrase “soluble powder” or “soluble product” refers to a powder preparation to be applied as a true solution of the active substance after solution in an aqueous solvent but which may contain insoluble inert ingredients.

As used herein, the phrase “water soluble powder” refers to a powder preparation to be applied as a true solution of the active substance after solution in water but which may contain insoluble inert ingredients.

As used herein, the phrase “wettable powder” refers to a powder preparation to be applied as suspension after dispersion in water.

As used herein, the term “solution” refers to a homogeneous mixture composed of two or more substances. Some skilled in the art refer to “solution” as being intermingled at the molecular level with neither remaining in solid or particulate form. Solution should be distinguished from non-homogeneous mixtures such as colloids and suspensions.

As used herein, the term “suspension” refers to a heterogeneous fluid containing solid particles that are sufficiently large for sedimentation.

As used herein, the term “colloid” refers to a type of chemical mixture where one substance is dispersed evenly throughout another. The particles of the dispersed substance are only suspended in the mixture, unlike a solution, where they are completely dissolved within.

As used herein, the term “chelator” refers to a bi- or multidentate ligand used in agricultural practice that is often an organic compound, also called chelant, chelating agent or sequestering agent. Chelators are chemicals that form soluble, complex molecules with certain metal ions, inactivating the ions so that they cannot normally react with other elements or ions to produce precipitates or scale. Chelators generally form one or more coordination bonds with a central metal ion, resulting in heterocyclic rings with the central metal ion as part of the ring. Examples of chelators are phosphines, amines, diphosphines, diamines, EDTA, EDDHA, HEDTA, DTPA, citrate, saccharate, gluconate, glucoheptonate and glycine. In agricultural practice, it is known that chelation increases the mobility of metal ions, especially in wet conditions. For example, chelated metal ions are not rainfast and are readily washed off from the site of application. In addition, this increased mobility introduces the risk for phytotoxicity due to rapid uptake by the plant tissue of the chelated metal ions.

As used herein, a “solubilizing amount of a chelator” refers to an amount of a particular chelator that enables a particular metal ion to become soluble in a particular solvent (e.g., water), thereby increasing substantially the mobility of the metal ion. In one embodiment, addition of a solubilizing amount of a chelator causes metal ions to be readily washed off from the site of application when exposed to moisture, such as rain or mist.

As used herein, the phrase “metal salt” refers to a chemical compound formed from, or that can be regarded as formed from, an acid and a metal by replacement of one or more hydrogen atoms in the acid molecules by positive ions formed from the metal.

As used herein, the term “ion” refers to an atom or group of atoms that has either lost one or more electrons, making it positively charged (a cation), or gained one or more electrons, making it negatively charged (an anion).

As used herein, the term “alkyl” refers to hydrocarbon containing normal, secondary, tertiary or cyclic carbon atoms. For example, an alkyl group can have 1 to 20 carbon atoms (i.e, C₁-C₂₀ alkyl), 1 to 10 carbon atoms (i.e., C₁-C₁₀ alkyl), or 1 to 6 carbon atoms (i.e., C₁-C₆ alkyl). Examples of suitable alkyl groups include, but are not limited to, methyl (Me, —CH₃), ethyl (Et, —CH₂CH₃), 1-propyl (n-Pr, n-propyl, —CH₂CH₂CH₃), 2-propyl (i-Pr, i-propyl, —CH(CH₃)₂), 1-butyl (n-Bu, n-butyl, —CH₂CH₂CH₂CH₃), 2-methyl-1-propyl (i-Bu, i-butyl, —CH₂CH(CH₃)₂), 2-butyl (s-Bu, s-butyl, —CH(CH₃)CH₂CH₃), 2-methyl-2-propyl (t-Bu, t-butyl, —C(CH₃)₃), 1-pentyl (n-pentyl, —CH₂CH₂CH₂CH₂CH₃), 2-pentyl (—CH(CH₃)CH₂CH₂CH₃), 3-pentyl (—CH(CH₂CH₃)₂), 2-methyl-2-butyl (—C(CH₃)₂CH₂CH₃), 3-methyl-2-butyl (—CH(CH₃)CH(CH₃)₂), 3-methyl-1-butyl (—CH₂CH₂CH(CH₃)₂), 2-methyl-1-butyl (—CH₂CH(CH₃)CH₂CH₃), 1-hexyl (—CH₂CH₂CH₂CH₂CH₂CH₃), 2-hexyl (—CH(CH₃)CH₂CH₂CH₂CH₃), 3-hexyl (—CH(CH₂CH₃)(CH₂CH₂CH₃)), 2-methyl-2-pentyl (—C(CH₃)₂CH₂CH₂CH₃), 3-methyl-2-pentyl (—CH(CH₃)CH(CH₃)CH₂CH₃), 4-methyl-2-pentyl (—CH(CH₃)CH₂CH(CH₃)₂), 3-methyl-3-pentyl (—C(CH₃)(CH₂CH₃)₂), 2-methyl-3-pentyl (—CH(CH₂CH₃)CH(CH₃)₂), 2,3-dimethyl-2-butyl (—C(CH₃)₂CH(CH₃)₂), 3,3-dimethyl-2-butyl (—CH(CH₃)C(CH₃)₃, and octyl (—(CH₂)₇CH₃).

As used herein, the term “aryl” refers to an aromatic hydrocarbon radical derived by the removal of one hydrogen atom from a single carbon atom of a parent aromatic ring system. For example, an aryl group can have 1 to 20 carbon atoms, 1 to 4 carbon atoms, 4 to 20 carbon atoms, 4 to 18 carbon atoms, 4 to 16 carbon atoms, 4 to 14 carbon atoms, 4 to 12 carbon atoms, 4 to 10 carbon atoms, 4 to 8 carbon atoms, or 4 to 6 carbon atoms. Typical aryl groups include, but are not limited to, radicals derived from benzene (e.g., phenyl), substituted benzene, naphthalene, anthracene, biphenyl, and the like.

As used herein, the teem “substituted alkyl” means alkyl in which one or more hydrogen atoms are each independently replaced with a non-hydrogen substituent.

As used herein, the term “heteroalkyl” refers to an alkyl group where one or more carbon atoms have been replaced with a heteroatom, such as, O, N, or S. For example, if the carbon atom of the alkyl group which is attached to the parent molecule is replaced with a heteroatom (e.g., O, N, or S) the resulting heteroalkyl groups are, respectively, an alkoxy group (e.g., —OCH₃, etc.), an amine (e.g., —NHCH₃, —N(CH₃)₂, etc.), or a thioalkyl group (e.g., —SCH₃). A heteroalkyl group can have, for example, 1 to 20 carbon atoms, 1 to 4 carbon atoms, 4 to 20 carbon atoms, 4 to 18 carbon atoms, 4 to 16 carbon atoms, 4 to 14 carbon atoms, 4 to 12 carbon atoms, 4 to 10 carbon atoms, 4 to 8 carbon atoms, or 4 to 6 carbon atoms. A C₁-C₆ heteroalkyl group means a heteroalkyl group having 1 to 6 carbon atoms.

As used herein, the term “phosphorus compound” refers to a chemical compound containing a phosphorus atom.

As used herein, the term “phosphorus acid” refers to a chemical compound having the following structure:

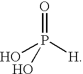

As used herein, the term “phosphonate” refers to a chemical compound having the following structure:

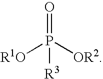

As used herein, the term phosphonates encompasses “hydrogen phosphonates,” which have the following structure:

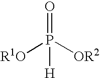

As used here, the terms “hydrogen phosphonate ester” and “monohydrogen phosphonate” refer to a chemical compound having the following structure:

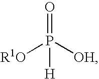

where R¹ is not hydrogen (e.g., alkyl, aryl, etc.)

As used herein, the terms “alkyl phosphonate ester” and “alkyl phosphite” refer to a chemical compound having the following structure:

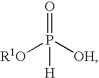

where R¹ is alkyl. Salts of alkyl phosphites are also possible, having the general structure:

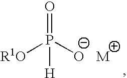

where R¹ is alkyl. For example, the terms “ethyl phosphite” and “ethyl hydrogen phosphonate” refer to a chemical compound having the following structure:

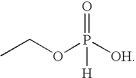

As used herein, the terms “phosphite” and “phosphorus acid, and/or a salt and/or a hydrate and/or an ester thereof” encompass phosphorus acid and its tautomeric forms, derivatives such as phosphite salts, i.e. salts of H₂PO₃⁻, HPO₃²⁻ or PO₃³⁻, or esters of phosphorus acid such as ethyl hydrogen phosphonate. Such derivatives may occur in different polymorphous forms. Phosphorus acid has the chemical formula:

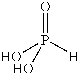

and is therefore distinct from phosphoric acid which has the chemical formula:

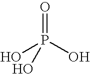

Salts of phosphoric acid are called phosphates and are commonly used as fertilizers but, in contrast to phosphites, do not have a strong direct effect on plant diseases.

As used herein, the term “buffer” or the phrase “buffer solution” refers to an aqueous solution consisting of a mixture of a weak acid and its conjugate base or a weak base and its conjugate acid.

As used herein, the term “buffer salt” refers to a chemical compound used to prepare a buffer or buffer solution.

As used herein, the term “weak acid” refers to an acid that dissociates incompletely and does not release all of its hydrogens in a solution, i.e., it does not completely donate all of its protons.

As used herein, the term “weak base” is a chemical base that does not ionize fully in an aqueous solution, or a chemical base in which protonation is incomplete.

As used herein, the term “acid salt” refers to a class of salts formed when a dibasic or tribasic acid has been neutralized to some degree, wherein one or more replaceable protons remain.

As used herein, the term “basic salts” refers to a class of salts having basic ion(s), for example, such as hydroxides or carbonate.

As used herein, the term “biocide” is a composition comprising one or more chemical substances or biological organisms capable of killing or inhibiting living organisms, usually in a selective way. Biocides are commonly used in medicine, agriculture, forestry, and in industry. Some substances used as biocides are also employed as anti-fouling agents or disinfectants under other circumstances: chlorine, for example, is used as a short-life biocide in industrial water treatment but as a disinfectant in swimming pools. As used herein, the term “pesticide” refers to composition comprising one or more chemical substances or biological organisms capable of killing or inhibiting a pest. Pests include, but are not limited to, insects, pathogens, weeds, molluscs, birds, mammals, fish, nematodes and microbes that compete with humans, e.g., for food. Pesticides can be classified into algicides, avicides, bactericides, fungicides, herbicides, insecticides, miticides/acaricides, molluscicides, nematicides, rodenticides, virucides, et al.

As used herein, the term “fungicide” refers to a composition comprising one or more chemical substances or biological organisms capable of killing or inhibiting both true fungi and their spores as well as oomycete pathogens, usually in a selective way. Fungicides are used both in agriculture and to fight fungal infections in animals. Fungicide can be either contact or systemic. In agriculture, a contact fungicide kills fungi by direct contact; a systemic fungicide spreads internally through the plant, thereby killing the fungi.

As used herein, the term “bactericide” refers to a composition comprising one or more chemical substances or biological organisms capable of killing or inhibiting bacteria, usually in a selective way.

As used herein, the term effective amount refers to the amount sufficient to control, including by preventing, reducing or eliminating, infections by pathogens. In one embodiment, control is measured as described in Example 10. As used herein, the term phytopathogenically effective amount refers to an amount sufficient to control phytopathogens, including bacteria and fungi.

As used herein, the verb “to comprise” as is used in this description and in the claims and its conjugations is used in its non-limiting sense to mean that items following the word are included, but items not specifically mentioned are not excluded. In addition, reference to an element by the indefinite article “a” or “an” does not exclude the possibility that more than one of the elements are present, unless the context clearly requires that there is one and only one of the elements. The indefinite article “a” or “an” thus usually means “at least one”.

As used herein, the phrase “Kraft lignins” are to be understood as polyphenolic products from the Kraft pulping process and their derivatives obtained by oxidation or other chemical modification.

As used herein, the phrase “organosolv lignins” are to be understood as polyphenolic products from delignification processes using organic solvents, and their chemical derivatives.

As used herein, lignosulfonates (a.k.a. lignosulphonates, lignosulfate, lignin sulfonate, ligninsulfonate, ligninsulfonic acid, lignosulfonic acid, lignosulfuric acid, or LST 7) are to be understood as water soluble anionic polymers which can be formed as by-products in the sulphite pulping process. Lignosulfonates have generally a wide molecular weight distribution, typically in the range of about 500 to about 150,000. Lignosulfonates may comprise different metal or ammonium ions as counter cations of the sulfonate groups, e.g. copper, zinc, calcium, sodium, potassium, magnesium, aluminum, et al.

As used herein, the term “solvent” refers to a liquid or gas, or a mixture of two or more types of liquid or gas, that dissolves solid, liquid, or gaseous solute, resulting in a solution. The most common solvent is water. Most other commonly-used solvents are organic (carbon-containing) chemicals.

As used herein, the term “plant” refers to any living organisms belonging to the kingdom Plantae (i.e., any genus/species in the Plant Kingdom). They include familiar organisms such as but not limited to trees, herbs, bushes, grasses, vines, ferns, mosses and green algae. The term refers to both monocotyledonous plants, also called monocots, and dicotyledonous plants, also called dicots. Examples of particular plants include but are not limited to corn, potatoes, roses, apple trees, sunflowers, wheat, rice, bananas, tomatoes, opo, pumpkins, squash, lettuce, cabbage, oak trees, guzmania, geraniums, hibiscus, clematis, poinsettias, sugarcane, taro, duck weed, pine trees, Kentucky blue grass, zoysia, coconut trees, and the like.

As used herein, the term “plant part” refers to any part of a plant including but not limited to the shoot, root, stem, seeds, stipules, leaves, petals, flowers, ovules, bracts, branches, petioles, internodes, bark, pubescence, tillers, rhizomes, fronds, blades, pollen, stamen, and the like. The two main parts of plants grown in some sort of media, such as soil, are often referred to as the “above-ground” part, also often referred to as the “shoots”, and the “below-ground” part, also often referred to as the “roots”.

The compositions and methods of the present invention can be applied to any plant or any part of any plant grown in any type of media used to grow plants (e.g., soil, vermiculite, shredded cardboard, water) or applied to plants or the parts of plants grown aerially, such as orchids or staghorn ferns. Such treatment can be for any purpose for controlling any plant pathogen, including as a prophylactic (i.e., preventative) treatment or in reducing or eliminating the presence of a plant pathogen on a plant. The presence of the plant pathogen may be non-infective or infective, or invasive or non-invasive, either before or during application of the compositions of the present invention.

### Fungal Plant Pathogens

In general, fungal plant diseases can be classified into two types: those caused by soilborne fungi and those caused by airborne fungi. Soilborne fungi cause some of the most widespread and serious plant diseases, such as root and stem rot caused by Fusarium spp. and root rot caused by Phytophthora spp. For example, Phytophthora parasitica var. nicotiana, a soilborne oomycete found in many tobacco growing regions worldwide, causes black shank, a highly destructive root and stem rot disease of many varieties of cultivated tobacco. Since airborne fungi can be spread long distances by wind, they can cause devastating losses, particularly in crops which are grown over large regions. A number of pathogens have caused widespread epidemics in a variety of crops. Important diseases caused by airborne fungi are stem rust (Puccinia graminis) on wheat, corn smut (Ustilago maydis) on corn, and late blight disease (Phytophthora infestans) on potato and tomato. Plasmopara viticola is an airborne oomycete that causes downy mildew disease on grape vines. The blue mold fungus (Peronospora tabacina) has caused catastrophic losses in tobacco crops, particularly in the United States and Cuba. Most of these fungal diseases are difficult to combat, and farmers and growers must use a combination of practices, such as sanitary measures, resistant cultivars, and effective fungicide against such diseases. Billions of dollars are spent annually for chemical control of plant-pathogenic fungi. As a result, there is today a real need for new, more effective and safe means to control plant-pathogenic fungi, particularly oomycete, which are responsible for major crop loss.

### Oomycetes

Oomycetes is a class of Oomycota, which is a phylum of filamentous protists, containing over around 70 genera and more than 800 known species (J. W. Deacon Modern mycology Edition: 3, Published by Wiley-Blackwell, 1997 ISBN 0632030771, 9780632030774).

“Oomycota” means “egg fungi”, referring to the oversize oogonia which house the female gametes (eggs). Despite the name and their superficial appearance, oomycetes are not fungi. They are unicellular heterokonts, physically resembling fungi. Oomycetes are commonly known as water molds (or water moulds) or downy mildew. They are microscopic, absorptive organisms that reproduce both sexually and asexually and are composed of mycelia, or a tube-like vegetative body (all of an organism's mycelia are called its thallus).

Oomycete cells differ from those of true fungi in that they have walls of cellulose and the amino acid hydroxyproline. They are heterotophic, either saphropytic or parasitic. The principle cell wall of oomycetes is not composed of chitin, as in the fungi, but is made up of a mix of cellulosic compounds and glycan. The nuclei within the filaments are diploid, with two sets of genetic information, not haploid as in the fungi.

Oomycetes do not synthesize sterols. They have cillia (small hairlike structures) that help it eat and move around. Among the oomycetes, these are produced as asexual spores called zoospores, which are released from sporangium and capitalize on surface water (including precipitation on plant surfaces) for movement.

Oomycetes may also germinate directly on the host plant by way of a germ tube. They also produce sexual spores, called oospores, that are translucent double-walled spherical structures used to survive adverse environmental conditions. This type of reproduction is known as “gametangical copulation”. A few produce aerial asexual spores that are distributed by wind.

The water molds are economically and scientifically important because they are aggressive plant pathogens. Some species can cause disease in fish. The majority can be broken down into three groups, although more exist.

The Phytophthora group is a genus that causes diseases such as dieback, late blight in potatoes, sudden oak death, rhododendron root rot, and ink disease in the American Chestnut.

The Pythium group is even more prevalent than Phytophythora and individual species have larger host ranges, usually causing less damage. Pythium damping off is a very common problem in greenhouses where the organism kills newly emerged seedlings. Mycoparasitic members of this group (e.g. P. oligandrum) parasitize other oomycetes and fungi, and have been employed as biocontrol agents. One Pythium species, Pythium insidiosum is also known to infect mammals.

The third group of oomycetes is the downy mildews, which are easily identifiable by the appearance of white “mildew” on leaf surfaces.

Oomycete-caused plant diseases include, but are not limited to, grape downy mildew (caused by Plasmopara viticola) and potato late blight (caused by Phytophthora infestans) and oomycete infestation of Arctotis (caused by Bremia lactucae), Chenopodium murale (caused by Peronospora farinosa), cucurbits and cucumbers (caused by Pseudoperonospora cubensis), grasses and grains (caused by Sclerospora graminicola), lettuce (caused by Bremia lactucae), onion (caused by Peronospora destructor), alfalfa (caused by Peronospora trifoliorum), lima bean (caused by Phytophthora phaseoli), sunflower (caused by Plasmopara halstedii), carrot (caused by Plasmopara nivea, also called Plasmopara crustosa), hops (caused by Pseudoperonospora humuli), crucifers (caused by Peronospora parasitica), spinach (caused by Peronospora effusa), beet (caused by Peronospora schachtii, also called Peronospora farinosa), peas (caused by Peronospora viciae), rose (caused by Peronospora sparsa), poppy (caused by Peronospora arborescens), tobacco (caused by Peronospora hyoscami), and violet (caused by Peronospora violae).

### Bacterial Plant Pathogens

Bacteria are microscopic prokaryotic and, for the most part, single-celled microorganisms. Of the over 15,000 identified species of bacteria most are saprophytic and are of great benefit in decomposing dead and rotting organisms thereby releasing their nutrients back into the environment. Most phytopathogenic bacteria are aerobic (live in the presence of oxygen) and some are facultative anaerobes which can grow with or without oxygen. There are around 200 species of phytopathogenic bacteria and almost all of them are narasites within the plant, on its surface, in plant debris or in the soil as saprophytes. Bacteria colonize a host by growing between the cells and absorbing the cells nutrients that leak into intercellular space or grow within the vascular tissue of the plant.

Depending on the species of bacteria and the tissue infected they produce and release enzymes that degrade cell walls, growth regulators that alter the plants normal growth, toxins that degrade cell membranes and complex sugars that pug water conducting tissue. A general classification of phytopathogenic prokaryotes can be found below:

```
Kingdom: Procaryotae
  Bacteria - Have cell membrane and cell wall and no nuclear membrane
  Division: Bacteria - Gram-positive
    Class: Proteabacteria - Mostly single celled bacteria.
      Family: Enterobacteriaceae
        Genus: Erwinia, causing fire blight of
          pear and apple, Stewart's wilt in corn,
          and soft rot of fleshy vegetables.
          Pantoea, causing wilt of corn.
          Serratia, S. marcescens, a
          phloem-inhabiting bacterium
          causing yellow vine disease of
          cucurbits.
          Sphingomonas, causing brown
          spot of yellow Spanish melon
          fruit.
      Family: Pseudomonadaceae
        Genus: Acidovorax, causing leaf spots in
          corn, orchids and watermelon.
          Pseudomonas, causing
          numerous leaf spots, blights,
          vascular wilts, soft rots, cankers,
          and galls.
          Ralstonia, causing wilts of
          solanaceous crops.
          Rhizobacter, causing the bacterial
          gall of carrots.
          Rhizomonas, causing the corky
          root rot of lettuce.
          Xanthomonas, causing numerous
          leaf spots, fruit spots, blights of
          annual and perennial plants,
          vascular wilts and citrus canker.
          Xylophilus, causing the bacterial
          necrosis and canker of grapevines.
      Family: Rhizobiaceae
        Genus: Agrobacterium, the cause of
          crown gall disease.
          Rhizobium, the cause of nitrogen-
          fixing root nodules in legumes.
      Family: still unnamed
        Genus: Xylella, xylem-inhabiting, causing
          leaf scorch and dieback disease
          on trees and vines.
          Candidatus liberobacter, Phloem
          inhabiting, causing citrus greening
          disease.
          Unnamed, laticifer-inhabiting,
          causing bunchy top disease of
          papaya.
  Division: Firmicutes - Gram-positive bacteria.
    Class: Firmibacteria - Mostly single celled bacteria.
        Genus: Bacillus, causing rot of tubers,
          seeds, and seedlings and white
          stripe of wheat.
          Clostridium, causing rot of stored
          tubers and leaves and wetwood of
          elm and poplar.
    Class: Thallobacteria - Branching bacteria.
        Genus: Arthrobacter, causing
          bacterial blight of holly, thought to
          be the cause of Douglas-fir
          bacterial gall.
          Clavibacter, causing bacterial
          wilts in alfalfa, potato, and tomato.
          Curtobacterium, causing wilt in
          beans and other plants.
          Leifsonia, causing ratoon stunting
          of sugarcane.
          Rhodococcus, causing fasciation
          of sweet pea.
          Streptomyces, causing common
potato scab. Fungicides
```

Many different types of fungicides have been produced commercially. Their active components and possible targeting pathways in pathogens are listed below in Table 1.

TABLE 1
Fungicides: possible targeting pathways and active components

| Possible Targeting Pathway | Active Component |
|---|---|
| Nuclear division, | zoxamide |
| β-tubulin | |
| | ethaboxam |
| Unknown | cymoxanil |
| Cell membrane permeability | propamocarb |
| Cell wall deposition and | dimethomorph |
| phospholipid inhibition | |
| | mandipropamid |
| | iprovalicarb |
| Respiration, MET-3 QoI | strobilurin series |
| | famoxadone |
| | fenamidone |
| Respiration, MET-3 QiI | cyazofamid |
| | amisulbrom |
| Respiration, uncoupler | fluazinam |
| Protein synthesis | fluopicolide |
| RNA synthesis | metalaxyl/mefenoxam |
| Multi-site enzyme | mancozeb |
| inhibitor | chlorothalonil |
| | coppers |

### Bactericide

A bactericide or bacteriocide is a substance that kills bacteria. Bactericides are either disinfectants, antiseptics or antibiotics.

The most used disinfectants can comprise: active chlorine (i.e., hypochlorites, chloramines, dichloroisocyanurate and trichloroisocyanurate, wet chlorine, chlorine dioxide etc.), active oxygen (peroxides, such as peracetic acid, potassium persulfate, sodium perborate, sodium percarbonate and urea perhydrate), iodine (iodpovidone (povidone-iodine, Betadine), Lugol's solution, iodine tincture, iodinated nonionic surfactants), concentrated alcohols (mainly ethanol, 1-propanol, called also n-propanol and 2-propanol, called isopropanol and mixtures thereof; further, 2-phenoxyethanol and 1- and 2-phenoxypropanols are used), phenolic substances (such as phenol (also called “carbolic acid”), cresols (called “Lysole” in combination with liquid potassium soaps), halogenated (chlorinated, brominated) phenols, such as hexachlorophene, triclosan, trichlorophenol, tribromophenol, pentachlorophenol, Dibromol and salts thereof), cationic surfactants, such as some quaternary ammonium cations (such as benzalkonium chloride, cetyl trimethylammonium bromide or chloride, didecyldimethylammonium chloride, cetylpyridinium chloride, benzethonium chloride) and others, non-quaternary compounds, such as chlorhexidine, glucoprotamine, octenidine dihydrochloride etc.), strong oxidizers, such as ozone and permanganate solutions; heavy metals and their salts, such as colloidal silver, silver nitrate, mercury chloride, phenylmercury salts, copper sulfate, copper oxide-chloride etc. Heavy metals and their salts are the most toxic, and environment-hazardous bactericides and therefore, their use is strongly oppressed or canceled; further, also properly concentrated strong acids (phosphoric, nitric, sulfuric, amidosulfuric, toluenesulfonic acids) and alkalis (sodium, potassium, calcium hydroxides).

As antiseptics (i.e., germicide agents that can be used on human or animal body, skin, mucoses, wounds and the like), few of the above mentioned disinfectants can be used, under proper conditions (mainly concentration, pH, temperature and toxicity toward man/animal). Among them, important are: properly diluted chlorine preparations (i.e. Daquin's solution, 0.5% sodium or potassium hypochlorite solution, pH-adjusted to pH 7-8, or 0.5-1% solution of sodium benzenesulfochloramide (chloramine B)), some iodine preparations, such as iodopovidone in various galenics (ointment, solutions, wound plasters), in the past also Lugol's solution, peroxides as urea perhydrate solutions and pH-buffered 0.1-0.25% peracetic acid solutions, alcohols with or without antiseptic additives, used mainly for skin antisepsis, weak organic acids such as sorbic acid, benzoic acid, lactic acid and salicylic acid some phenolic compounds, such as hexachlorophene, triclosan and Dibromol, and cation-active compounds, such as 0.05-0.5% benzalkonium, 0.5-4% chlorhexidine, 0.1-2% octenidine solutions.

Bactericidal antibiotics kill bacteria; bacteriostatic antibiotics only slow their growth or reproduction. Aminoglycosidic antibiotics are usually considered bactericidal, although they may be bacteriostatic with some organisms. They act by binding irreversibly to 30s ribosomal subunit, reducing translation fidelity leading to inaccurate protein synthesis. The other effect is the inhibition of protein synthesis due to premature separation of the complex between mRNA and ribosomal proteins. The final result is bacterial cell death. Other bactericidal antibiotics include the fluoroquinolones, nitrofurantoin, vancomycin, monobactams, co-trimoxazole, and metronidazole.

Plant diseases that can be controlled by metal ions, for example, copper (II), zinc(II), aluminum(III) based fungicides are many and well-known to the person trained in the art of crop protection. Examples include scab on apple (Venturia inaequalis), fire blight on apple (Erwinia amylovora), Phytophthora pod rot on cocoa (Phytophthora megakarya and Phytophthora palmivora), rust on wheat (Puccinia species), blast on rice (Piricularia oryzae), brown path in turf grass (Rhizoctonia and Helminthosporium species), grey mould (Botrytis) on many plant species, for instance strawberry, potato and grapevine, downy and powdery mildew on grapevine (Plasmopara viticola and Uncinula necator), Black Sigatoka on banana (Mycosphaerella fijiensis) and late blight on potato (Phytophthora infestans).

### Pesticide Application

In principle, a simple path to reduce the quantities of chemical pesticides released into the environment is to reduce the total amounts of compounds being applied for pest control. It is obvious that precise targeting and uniform distribution of the chemicals over the intended site of application is crucial to keep the input of chemicals to the environment as low as possible. This requires optimal formulation and optimal application procedures. At a macroscopic level, spray drift reduction (i.e. reduction of movement of pesticide through air to a site other than the intended site) is a well-known method to substantially reduce chemical input reductions without loss of efficacy.

Similarly, at a microscopic level, effective distribution of pesticide chemicals can significantly reduce the absolute quantities of chemicals without loss of efficacy. For example, it is evident that a target area can be covered more uniformly and with a smaller absolute quantity of pesticide if the compound is applied as a solution rather than a particulate suspension. On the other hand, however, under practical agricultural conditions active ingredients that are highly soluble in water are readily transported away from the site of their intended deployment of biocide activity, which results in substantially reduced protective power of the pesticide. Therefore, in an ideal situation the active ingredients before and during application are at least present as dissolved molecules or as part of dissolved molecular complexes, whereas after application the active ingredients remain relatively immobile over the long term.

Pesticidal compositions, either diluted or undiluted, can be applied in a number of different ways. For small scale application of a liquid pesticidal composition, backpack tanks, hand-held wands, spray bottles, or aerosol cans can be utilized. For somewhat larger scale application of liquid pesticidal compositions, tractor drawn rigs with booms, tractor drawn mist blowers, airplanes or helicopters equipped for spraying, or fogging sprayers can all be utilized. Small scale application of solid formulations can be accomplished in a number of different ways, examples of which are: shaking product directly from the container or gravity-application by human powered fertilizer spreader. Large scale application of solid formulations can be accomplished by gravity fed tractor drawn applicators, or similar devices.

Under certain conditions, it has been found desirable to inject pesticides, liquid fertilizers, or other liquid chemical solutions into the soil below the surface to improve crop yields. One common method of injecting such liquids into the soil is to provide a sharpened point on the lower end of a shank and a tube extending down the shank behind the point. As the point is moved forwardly through the soil, it opens a furrow and liquid conducted downwardly through the tube soaks into the soil in the furrow. This arrangement does not disperse the liquid laterally into the soil and the liquid is concentrated in a narrow band. When a pesticide is used, efficient pest control requires that the pesticide be placed in a precise relationship to the planted seed. If the pesticide is applied after the seed has been planted, it is difficult to assure that the pesticide will be injected at the proper location. Also, the subsequent application of the pesticide requires a separate field operation.

Pesticides can be applied to the seed prior to planting, in the form of a seed treatment, or coating, to protect against soil-borne risks to the plant. Additionally, these coatings can provide supplemental chemicals and nutrients designed to encourage growth. A typical seed coating can include a nutrient layer-containing nitrogen, phosphorus, and potassium, a rhizobial layer-containing symbiotic bacteria and other beneficial microorganisms, and a pesticide layer to make seed less vulnerable to pest.

One of the more common forms of pesticide application, especially in conventional agriculture, is the use of mechanical sprayers. Hydraulic sprayers consist of a tank, a pump, a lance (for single nozzles) or boom, and a nozzle (or multiple nozzles). Sprayers convert a pesticide formulation, often containing a mixture of water (or another liquid chemical carrier, such as fertilizer) and chemical, into droplets, which can be large rain-type drops or tiny almost-invisible particles. This conversion is accomplished by forcing the spray mixture through a spray nozzle under pressure. The size of droplets can be altered through the use of different nozzle sizes, or by altering the pressure under which it is forced, or a combination of both. Large droplets have the advantage of being less susceptible to spray drift, but require more water per unit of land covered. Small droplets are able to static electricity to maximize contact with a target organism, but require very still wind conditions.

In agriculture, a sprayer is a piece of equipment that applies herbicides, pesticides, and fertilizers to agricultural crops. Sprayers range in size from man-portable units (typically backpacks with spray guns) to self-propelled units similar to tractors, with boom mounts of 60-151 feet in length.

Pesticides can also be applied by method called aerial application, commonly called crop dusting, which involves spraying crops with fertilizers, pesticides, and fungicides from an agricultural aircraft. The specific spreading of fertilizer is also known as aerial topdressing. Agricultural aircraft are often purpose-built, though many have been converted from existing airframes. Helicopters are sometimes used, and some aircraft serve double duty as water bombers in areas prone to wildfires.

Traditional agricultural crop pesticides can either be applied pre-emergent or post-emergent, a term referring to the germination status of the plant. Pre-emergent pesticide application, in conventional agriculture, attempts to reduce competitive pressure on newly germinated plants by removing undesirable organisms and maximizing the amount of water, soil nutrients, and sunlight available for the crop.

Post-emergent pesticide application requires the use of specific chemicals chosen to minimize harm to the desirable target organism. An example is 2,4-Dichlorophenoxyacetic acid, which will injure broadleaf weeds (dicots) but leave behind grasses (monocots). Such a chemical has been used extensively on wheat crops, for example. A number of companies have also created genetically-modified organisms that are resistant to various pesticides. Examples include glyphosate-resistant soybeans and Bt maize, which change the types of formulations involved in addressing post-emergent pesticide pressure. It is important to also note that even given appropriate chemical choices, high ambient temperatures or other environmental influences, can allow the non-targeted desirable organism to be damaged during application. As plants have already germinated, post-emergent pesticide application necessitates limited field contact in order to minimize losses due to crop and soil damage. Typical industrial application equipment will utilize very tall and narrow tires and combine this with a sprayer body which can be raised and lowered depending on crop height. These sprayers usually carry the label ‘high-clearance’ as they can rise over growing crops, although usually not much more than 1 or 2 meters high. In addition, these sprayers often have very wide booms in order to minimize the number of passes required over a field, again designed to limit crop damage and maximize efficiency. In industrial agriculture, spray booms 120 feet (40 meters) wide are not uncommon, especially in prairie agriculture with large, flat fields. Related to this, aerial pesticide application is a method of top dressing a pesticide to an emerged crop which eliminates physical contact with soil and crops.

Sprayers and other application equipments include, but are not limited to hydraulic sprayer, motorized mistblowers, CDA/ULV application equipment, foggers, granule application equipment, dust application equipment. For example, sprayers are described in U.S. Pat. Nos. 3,970,121, 3,995,667, 4,186,783, 4,209,134, 4,275,846, 4,344,469, 4,356,528, 4,358,054, 4,362,275, 4,470,550, 4,690,331, 4,702,416, 4,893,755, 5,014,914, 5,172,861, 5,241,781, 5,429,305, 5,614,558, 5,816,498, 5,998,475, 6,126,757, 6,199,000, 6,375,089, 6,425,531, 6,558,079, 6,558,080, 6,576,601, 6,779,489, 7,194,980, 7,306,167, 7,388,662 and 7,501,979. Each of the patents, patent publications cited here is incorporated by reference in its entirety herein, including all drawings/photographs that are a part thereof.

### Metal-Containing Biocides

Inorganic copper compounds were the first biocides developed and used. Noteworthy is the reaction product of copper sulphate and calcium hydroxide known as the Bordeaux mixture, which was developed at the end of the 19^{th} century and which is still widely used to control many fungal and bacterial plant diseases. Other examples of inorganic copper salts used as biocides are copper oxychlorides (e.g. sold as Oxycor®), copper hydroxides (e.g. sold as Kocide®, Champ®, and Nu-Cop®), copper oxides (e.g. sold as Nordox®), and copper ammonium carbonate (e.g. sold as Copper Count-N®, and Kop-R-Spray®). Solubility of copper salts ranges from nil (copper oxide) to relatively high (copper sulphate). Besides inorganic copper salts, inorganic salts of other metals are known for their biocidal activity.

Little is known about the mode of action of metal containing compounds as biocide. It is generally assumed that copper ions can enter fungal spores and denature proteins and inactivate enzymes. In a published study it was shown that copper fungicides killed spores of Venturia inaequalis by inhibiting mitochondrial respiration (Montag J, Schreiber L, Schönherr J, “An In vitro study of the nature of protective activities of copper sulphate, copper hydroxide and copper oxide against conidia of Venturia inaequalis”, J. Phytopathol 154: 474-481, 2006). It is well known that mobile copper ions, either present as free ions or as complexed (or chelated) ions, exhibit higher efficacy per number of molecules than sparingly soluble or insoluble copper compounds. Physical contact between the insoluble copper compounds and the fungal spores or micro-organisms is essential for their biocide effects (Montag J, Schreiber L, Schönherr J, “An In vitro study of the nature of protective activities of copper sulphate, copper hydroxide and copper oxide against conidia of Venturia inaequalis”, J. Phytopathol 154: 474-481, 2006.). It is well known that only a minor fraction of each of the insoluble metal particles is involved in the biocide action, and that this provides opportunities to reduce the quantitative input of metal without loss of efficacy.

Metal ions or compounds containing metal ions can be incorporated as active constituents in compositions comprising other active ingredients. Known are combinations with phosphorus acid, and/or a salt and/or an ester thereof. Phosphorus acid (H₃PO₃) or phosphorus acid salts (phosphites or phosphonates) are particularly effective against Oomycete pathogens, such as Phytophthora, Pythium and downy mildews in a number of crops. As is well known in the art, phosphorus acid and salts thereof are distinct from phosphoric acid (H₃PO₄) and salts thereof (phosphates). It is believed that phosphorus acid fungicides act directly on the pathogen and additionally stimulate the plant's natural defense response against the pathogen. The combination of copper with phosphite as fungicidal composition is disclosed at least as early as in the late seventies of the 20^{th} century. For example, the preparation and fungicidal application of cuprous phosphite (Cu₂HPO₃.2H₂O) is disclosed in U.S. Pat. No. 4,075,324. Example 1 of U.S. Pat. No. 4,075,324 discloses such a fungicidal composition as a wettable powder which further contains calcium lignosulfate. Combinations of metal ions and phosphite can be extended furthermore with additional fungicides. For example, fungicidal compositions consisting of a copper(II) salt of phosphorus acid and at least another metal salt of phosphorus acid, combined with or without one or more fungicidal compounds are disclosed in WO 2006/128677. Fungicidal compositions comprising the combination of copper fungicides with phosphorus acid and so-called mandelamide type fungicides are disclosed in WO 2006/136551.

In aqueous fungicidal compositions comprising copper(II) ions and phosphite ions, these ions are mainly present as solid copper(II) phosphite particles, since solubility of copper(II) phosphite in water is extremely low. Examples of other metal ions that form precipitates with phosphite in aqueous compositions include, manganese(I), magnesium(II), manganese(III), zinc(II), manganese(II), nickel(II), silver(I), silver(II), titanium(II), titanium(III), titanium(IV), aluminum(III) and copper(I). Due to this physical presence of copper(II) and/or other fungicidal metal ions as part of solid particles when combined with phosphite ions, homogeneous application of copper(II) and/or the other metal ions and phosphite over the intended site of application is hampered, which substantially reduces their efficacy against the pathogens. Thus, it will be highly desirable to prevent Cu(II) and other metal ions from precipitating with phosphite ions in aqueous fungicidal compositions comprising Cu(II) ions and/or other metal ions and phosphite ions.

A well-known method to prevent metal ions from precipitation with other molecules is complexation of the metal ions with chelators. Referring to U.S. Pat. No. 5,514,200, the phosphite containing fertilizer Nutri-Phite® is especially recommended for its compatibility with metal ions like copper(II) because it contains chelating organic acids like citrate that prevent metal ions like copper(II) from forming precipitates with phosphite. Furthermore, in patent application WO 2002/060248 biocide compositions are disclosed which contain one or more metal ions, phosphite and one or more chelators like citrate.

However, soluble chelates of metal ions are readily washed or transported away from the site of application. It is generally acknowledged that soluble chelates of metal ions, as do soluble metal ions, introduce the risk for phytotoxicity due to rapid uptake by the plant of these mobile or mobilised metal ions. In addition it is common knowledge that in agricultural practice soluble metal salts or soluble chelates of metal ions readily are washed off from the site of application during moist or rainy periods. Because of those reasons insoluble biocide copper compounds or insoluble biocide metal salts often are desired. Thus, it would be highly advantageous to prevent Cu(II) and other metal ions in aqueous fungicidal compositions from becoming part of highly mobile complexes like soluble chelates.

### Compositions of the Present Invention

The present invention provides a composition comprising a soluble combination comprising at least one lignosulfonate, at least one metal salt, and at least one phosphorus compound, wherein the composition excludes a solubilizing amount of a chelator. In addition, the composition is at a pH of between about 4.8 and about 5.8.

The present inventors have found that surprisingly the formation of metal phosphite precipitate at conditions between a pH of 3 to 7, for example, the pH is between about 4.5 to about 6.0, in aqueous compositions of metal salt(s) and phosphite salt(s) is markedly prevented by the presence of a lignosulfonate. Said action by the lignosulfonate is unforeseeable and completely unexpected since it is known that the complexing capacity of lignins and lignin derivatives like Kraft lignin for metal ions decreases with decreasing pH (Kulik F, Wieber J, Pethica B, Zuman P, “Binding of copper(II) and Zinc (II) ions on various lignins”, J. Electroanal. Chem. 214:331-342, 1986), and that the complexing capacity of lignosulfonate is very low in the acidic pH-range. This is illustrated by the following Table 2 showing the percentage of copper ions (Cu) complexed to lignosulfonate (LS) at different pH and at different amount of Cu per 100 gram of lignosulfonate (data derived from Borregaard LignoTech Ltd).

TABLE 2
Percentage of copper ions (Cu) complexed to lignosulfonate
(LS) at different pH and at different amount of Cu per
100 gram of lignosulfonate

| | % complexed Cu | | |
|---|---|---|---|
| pH | 11 g Cu/100 g LS | 8.5 g Cu/100 g LS | 5.4 g Cu/100 g LS |
| 9 | 100 | 100 | 100 |
| 7 | 92 | 89 | 82 |
| 5 | 18 | 15 | 13 |
| 3 | 10 | 10 | 9.5 |

The low complexing capacity, amongst other characteristics of lignosulfonates, makes lignosulfonate very suitable as an additive to fungicidal compositions comprising metal ions and phosphite.

As shown at the end of Example 8, the compositions of the present invention are not easily washed away, unlike chelated metal ions, which are not rainfast. In addition, even in compositions of the present invention with two times the highest percentage of copper described in this application, the phytotoxicity issues experienced with chelated metal ions do not arise.

Although applicants do not wish to be bound by any particular theory, based on the following observations, it is thought that the lignosulfonate prevents precipitation by interacting not only with the metal ion but with the phosphorus compound as well. First, in the pH range of the present invention, only about 15% of the metal is complexed to the lignosulfonate, as described above, such that some metal ions are free and should be available to react with the phosphorus compound, forming a precipitate. Surprisingly, however, this does not happen. In addition, as described in Example 4, the solubilizing property of lignosulfonate is particular to the phosphorus compounds. Lignosulfonate is not able to prevent precipitation of metal and phosphoric acid-based compounds (such as phosphates).

Again, without wishing to be bound by any theory, it is speculated that the different physical properties of lignosulfonate compared to chelators contribute to its advantageous characteristics. It is observed that after application of the composition of the present invention to a plant, the composition dries onto the plant tissue, forming a film. Lignosulfonate is much larger and stickier than a chelator, so it may (i) become gel-like, sticking to the foliage and increasing rainfastness and (ii) cause copper to seep out of the composition gradually over time, decreasing phytotoxicity.

The metal salt in said combination comprises one or more metal ions selected from the group consisting of copper(I), copper(II), zinc(II), manganese(I), manganese(II), manganese(III), silver(I), silver(II), titanium(II), titanium(III), titanium(IV), and aluminum(III). For example, metal salts may include, but not be limited to, copper carbonate, copper hydroxide, copper oxychloride, copper sulfates, copper oxides, copper nitrate, copper salts of fatty and rosin acids, copper lignosulfonate, copper diisopropoxide, copper(II) chloride, copper(I) chloride, copper cyanide, copper bromide, copper iodide, copper tetraiodomercurate, copper fluoride, zinc oxide, zinc sulphate, zinc sulphite, zinc lignosulfonate, zinc diethoxide, zinc bromide, zinc chloride, zinc cyanide, zinc fluoride, zinc iodide, zinc salts of fatty and rosin acids, zinc nitrate hydrate, zinc phosphate, zinc selenite, zinc tetrafluoroborate, magnesium sulphate, manganese lignosulfonate, manganese sulphite, manganese sulphite, manganese chloride, manganese bromide, manganese fluoride, manganese nitrate, manganese iodide, manganese diethoxide, manganese salts of fatty and rosin acids, aluminum bromide, aluminum chloride, aluminum fluoride, aluminum hydroxide, aluminum iodide, aluminum sulphite, aluminum sulphate, aluminum salts of fatty and rosin acids, or mixtures of thereof. The metal ion may have different valences or mixed valences. The metal ion may be in a complex form. The concentration of metal(s), as ion(s) of the metal salt(s), in certain concentrated formulations of the present invention is at least about 0.25%, about 1%, about 2.5%, or about 5%, by weight. For example, the concentration of metal(s), as ion(s) of the metal salt(s) in certain concentrated formulations of the present invention typically range from 0.25% to 5%, by weight, or in the range from 2.5% to 4%, by weight. In some particular instances, the concentration of metal(s), as ion(s) of the metal salt(s) in certain concentrated formulations of the present invention may be greater than 5%, or greater than 10%, or greater than 15%.

The lignosulfonate includes, but is not limited to sodium lignosulfonate (e.g. sold as Borresperse NA®, Borregaard LignoTech Ltd, Germany), calcium lignosulfonate (e.g. sold as Borresperse CA®, Borregaard LignoTech Ltd, Germany), ammonium lignosulfonate, potassium lignosulfonate, modified lignosulfonate, derivatives of lignosulfonate, or mixtures thereof. Modified lignosulfonates, and derivatives of lignosulfonates are described in U.S. Pat. Nos. 3,639,263, 3,923,532, 4,006,779, 4,017,475, 4,019,995, 4,069,217, 4,088,640, 4,133,385, 4,181,652, 4,186,242, 4,196,777, 4,219,471, 4,236,579, 4,249,606, 4,250,088, 4,267,886, 4,269,270, 4,293,342 4,336,189, 4,344,487, 4,594,168, 4,666,522, 4,786,438, 5,032,164, 5,075,402, 5,286,412, 5,401,718, 5,446,133, 5,981,433, 6,420,602, and 7,238,645.

The concentration of lignosulfonate in certain concentrated formulations of the present invention is at least about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%, by weight. For example, the concentration of lignosulfonate in certain concentrated formulations of the present invention may be in a range from about 15% to about 55%, from about 15% to about 41%, from about 18% to 41%, or from about 25% to about 41%, by weight. Or for example, the concentration of lignosulfonate in the certain concentrated formulations may be at least about 25% by weight. Or for example, the concentration of lignosulfonate in certain concentrated formulations may be equal to or less than about 55%.

Importantly, to prevent the formation of metal phosphite precipitate, the ratio of metal(s), as ion(s) of the metal salt(s) to lignosulfonate (in weight) in any composition of the present invention is at least about 1:5 (w/w), about 1:6 (w/w), about 1:7 (w/w), about 1:8 (w/w), about 1:9 (w/w), about 1:10 (w/w), about 1:11 (w/w), about 1:12 (w/w), about 1:13 (w/w), about 1:14 (w/w), about 1:15 (w/w), about 1:16 (w/w), about 1:17 (w/w), about 1:18 (w/w), about 1:19 (w/w), about 1:20 (w/w), about 1:21 (w/w), about 1:22 (w/w), about 1:23 (w/w), about 1:24 (w/w), about 1:25 (w/w), about 1:26 (w/w), about 1:27 (w/w), about 1:28 (w/w), about 1:29 (w/w), about 1:30 (w/w), about 1:31 (w/w), about 1:32 (w/w), about 1:33 (w/w), about 1:34 (w/w), about 1:35 (w/w), about 1:36 (w/w), about 1:37 (w/w), about 1:38 (w/w), about 1:39 (w/w), about 1:40 (w/w), about 1:41 (w/w), about 1:42 (w/w), about 1:43 (w/w), about 1:44 (w/w), about 1:45 (w/w), about 1:46 (w/w), about 1:47 (w/w), about 1:48 (w/w), about 1:49 (w/w), about 1:50 (w/w), about 1:51 (w/w), about 1:52 (w/w), about 1:53 (w/w), about 1:54 (w/w), about 1:55 (w/w), about 1:56 (w/w), about 1:57 (w/w), about 1:58 (w/w), about 1:59 (w/w), about 1:60 (w/w), about 1:61 (w/w), about 1:62 (w/w), about 1:63 (w/w), about 1:64 (w/w), about 1:65 (w/w), about 1:66 (w/w), about 1:67 (w/w), about 1:68 (w/w), about 1:69 (w/w), about 1:70 (w/w), about 1:71 (w/w), about 1:72 (w/w), about 1:73 (w/w), about 1:74 (w/w), about 1:75 (w/w), about 1:76 (w/w), about 1:77 (w/w), about 1:78 (w/w), about 1:79 (w/w), about 1:80 (w/w), about 1:81 (w/w), about 1:82 (w/w), about 1:83 (w/w), about 1:84 (w/w), about 1:85 (w/w), about 1:86 (w/w), about 1:87 (w/w), about 1:88 (w/w), about 1:89 (w/w), about 1:90 (w/w), about 1:91 (w/w), about 1:92 (w/w), about 1:93 (w/w), about 1:94 (w/w), about 1:95 (w/w), about 1:96 (w/w), about 1:97 (w/w), about 1:98 (w/w), about 1:99 (w/w), about 1:100 (w/w), about 1:110 (w/w), about 1:120 (w/w), about 1:130 (w/w), about 1:140 (w/w), about 1:150 (w/w), about 1:160 (w/w), about 1:170 (w/w), about 1:180 (w/w), about 1:190 (w/w), about 1:200 (w/w), about 1:300 (w/w), about 1:400 (w/w), about 1:500 (w/w), about 1:600 (w/w), about 1:700 (w/w), about 1:800 (w/w), about 1:900 (w/w), about 1:1000 (w/w), about 1:2000 (w/w), about 1:3000 (w/w), about 1:4000 (w/w), about 1:5000 (w/w), about 1:6000 (w/w), about 1:7000 (w/w), about 1:8000 (w/w), about 1:9000 (w/w), about 1:10000 (w/w). For example, the ratio of metal(s), as ion(s) of the metal salt(s) to lignosulfonate (in weight) in the composition is between about 1:5 (w/w) and about 1:10000 (w/w), or between about 1:5 (w/w) and about 1:1000 (w/w), or between about 1:5 (w/w) and about 1:500 (w/w), or between 1:5 (w/w) and about 1:200 (w/w), or between about 1:5 (w/w) and about 1:100 (w/w), or between about 1:5 (w/w) and about 1:50 (w/w), or between about 1:5 (w/w) and about 1:20 (w/w), or between about 1:10 (w/w) and about 1:10000 (w/w), or between about 1:10 (w/w) and about 1:1000 (w/w), or between about 1:10 (w/w) and about 1:500 (w/w), or between about 1:10 (w/w) and about 1:200(w/w), or between about 1:10 (w/w) and about 1:100 (w/w), or between about 1:10 (w/w) and about 1:50 (w/w), or between about 1:10 (w/w) and about 1:20 (w/w).

The interaction between lignosulfonates and metals that prevents precipitation of phosphite salts has several features that distinguish it from true chelation:
At the pH used in our compositions, only about 15% of the copper is associated with the lignosulfonate (see Tables in the Examples section). This means that 85% of the copper should be free to form precipitates with phosphite, which however does not occur, when phosphite is added to a solution of lignosulfonate and copper ions at pH 5.
The prevention of formation of precipitates is specific to phosphite (see the Examples section). As discussed elsewhere herein, precipitates do form with other ions than phosphite, for instance phosphate. This goes against the American Society for Testing and Materials (‘ASTM’) definition of chelation (“inactivating the ions so that they cannot normally react with other elements or ions to produce precipitates or scale”).
Chelates are soluble complexes, that have good mobility in water. The copper in the compositions of present invention however, shows reduced mobility after deposition on the leaf (even in rainy weather, as shown in Example 8).
Chelates are known to be taken up into plants very easily. We however never observed copper toxicity upon use of our compositions, even at double the recommended dosage of the compositions.

The phosphorus compound used in the present invention may be selected from the group consisting of phosphorus acid, phosphite salts (i.e., salts of phosphorus acid) that solubilize spontaneously at the pHs of this invention without addition of a chelator or additional compound such as lignosulfonate at the pHs of this invention, hydrogen phosphonate esters (i.e., esters of phosphorus acid or alkyl phosphites), and salts of hydrogen phosphonate esters and combinations thereof that solubilize spontaneously at the pHs of this invention without addition of a chelator or additional compounds such as lignosulfonate. In one embodiment, these spontaneously soluble phosphite salts are fanned from potassium or sodium.

Suitable examples of phosphite salts include, but are not limited to, KH₂PO₃, K₂HPO₃, K₃PO₃, NaH₂PO₃, Na₂HPO₃, Na₃PO₃ et al. A mixture of e.g. KH₂PO₃ and K₂HPO₃ can easily be obtained by e.g. adding KOH or K₂CO₃ to a final pH of 5.0-6.0 to a KH₂PO₃ composition.

Hydrogen phosphonate ester, a.k.a. monohydrogen phosphonate, refers to a chemical compound having the following structure:

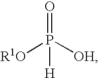

where R¹ is not hydrogen (e.g., alkyl, aryl, etc.). For example, R¹ is an alkyl selected from a group consisting of methyl (Me, —CH₃), ethyl (Et, —CH₂CH₃), 1-propyl (n-Pr, n-propyl, —CH₂CH₂CH₃), 2-propyl (i-Pr, i-propyl, —CH(CH₃)₂), 1-butyl (n-Bu, n-butyl, —CH₂CH₂CH₂CH₃), 2-methyl-1-propyl (i-Bu, i-butyl, —CH₂CH(CH₃)₂), 2-butyl (s-Bu, s-butyl, —CH(CH₃)CH₂CH₃), 2-methyl-2-propyl (t-Bu, t-butyl, —C(CH₃)₃), 1-pentyl (n-pentyl, —CH₂CH₂CH₂CH₂CH₃), 2-pentyl (—CH(CH₃)CH₂CH₂CH₃), 3-pentyl (—CH(CH₂CH₃)₂), 2-methyl-2-butyl (—C(CH₃)₂CH₂CH₃), 3-methyl-2-butyl (—CH(CH₃)CH(CH₃)₂), 3-methyl-1-butyl (—CH₂CH₂CH(CH₃)₂), 2-methyl-1-butyl (—CH₂CH(CH₃)CH₂CH₃), 1-hexyl (—CH₂CH₂CH₂CH₂CH₂CH₃), 2-hexyl (—CH(CH₃)CH₂CH₂CH₂CH₃), 3-hexyl (—CH(CH₂CH₃)(CH₂CH₂CH₃)), 2-methyl-2-pentyl (—C(CH₃)₂CH₂CH₂CH₃), 3-methyl-2-pentyl (—CH(CH₃)CH(CH₃)CH₂CH₃), 4-methyl-2-pentyl (—CH(CH₃)CH₂CH(CH₃)₂), 3-methyl-3-pentyl (—C(CH₃)(CH₂CH₃)₂), 2-methyl-3-pentyl (—CH(CH₂CH₃)CH(CH₃)₂), 2,3-dimethyl-2-butyl (—C(CH₃)₂CH(CH₃)₂), 3,3-dimethyl-2-butyl (—CH(CH₃)C(CH₃)₃, and octyl (—(CH₂)₇CH₃), and mixture of thereof.

Salts of alkyl phosphites refers to a chemical compound having the general structure:

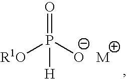

where R¹ is alkyl and M is metal. In one embodiment, the present invention provides a composition comprising a soluble combination comprising at least one lignosulfonate, at least one metal salt, at least one phosphorus compound, and at least one compound (e.g., a buffer salt) as to form a composition with a pH of at least about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5 about 6.6, about 6.7, about 6.8, about 6.9, or about 7.0, and wherein the composition excludes a solubilizing amount of a chelator. For example, the pH of the said composition is in a range between about 4.7 and about 6.0, between about 4.8 and about 5.8, or between about 5.0 to about 5.5. Suitable examples of compounds to form a composition with certain pH include, but not limited to acid, acid salts, basic and basic salts, for example, HCl, H₂NO₃, H₂SO₄, NaHCO₃, NaHS, NaHSO₄, NaH₂PO₄, Na₂HPO₄, NaHSO₃, KHCO₃, KHS, KHSO₄, KH₂PO₄, K₂HPO₄, KHSO₃, NaOH, KOH, Mg(OH)₂, Na₂CO₃, K₂CO₃, KHCO₃, CaCO₃, MgCO₃, Na₂S, K₂S et al.

Alternatively, the present invention provides a composition comprising a soluble combination comprising at least one lignosulfonate, at least one metal salt, at least one phosphorus compound, and a buffer with a pH of at least about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, or about 7.0, and wherein the composition excludes a solubilizing amount of a chelator. For example, the pH of the said composition is in a range between about 4.7 and about 6.0, between about 4.8 and about 5.8, or between about 5.0 to about 5.5. Method of making such a buffer is well-known by people in the field.

In one embodiment, the composition is a water soluble powder.

In one embodiment, the composition is in liquid form.

In one embodiment, the composition is a solution. An example of a solution useful in preparing the compositions of the instant invention is one in which the solvent is water. The water to be used in preparing the compositions of the present invention may be tap water, spring water, purified water, mineral water, distilled water, bottled water or other form of water useful as a solvent.

The composition according to the invention may optionally comprise additional components. In particular said composition may comprise one or more ionic or non-ionic surfactants, for instance as spreader, wetting agent, dispersant, or emulsifier. Suitable examples of such surfactants include phenolsulfonic acid salts, naphthalenesulfonic acid salts, polycondensates of alkylene oxides with fatty alcohols, with fatty acids, with fatty amines, or with substituted phenols, salts of sulfosuccinic acid esters, fatty acid esters of polyols, esters of polyoxyethylated alcohols or phenols, and derivatives thereof containing sulfate, sulfonate, phosphate or carboxylate groups.

The composition according to the invention may optionally also comprise an adhesive which improves sticking of the bioactive compound(s) to the intended site of application. Suitable examples of such sticking agents are latex based products like Prolong® (Holland Fyto B.V., The Netherlands), Bond® (Loveland Industries Ltd), and Guard 2000® (Headland Agrochemicals Ltd), pinolene/terpene based products like Nu-film® (Hygrotech Saad) and Spray-Fast® (Mandops) and long chain polysaccharides like xanthan gum and guar gum. The composition according to the invention may optionally also contain one or more agriculturally appropriate support, carrier or filler. Suitable examples of such components include clays, silicates, resins, waxes, organic solvents, and mineral and plant oils or derivatives thereof. In general, other components which meet the terms of the conventional formulation techniques may be included.

For example, the composition according to the present invention is a liquid, an aqueous composition, or a solution, which can be used for application by means of immersion, pouring, or spraying. Said liquid, for example, an aqueous composition, comprises 0.1 wt. % to 40 wt. % of dry matter or 0.5 wt. % to 30 wt. % of dry matter, calculated on the total weight of the aqueous composition. The present invention also includes solid compositions like pellets, granules and tablets and liquid concentrates or pastes which must be dissolved and/or diluted before application.

The composition according to the present invention shows systemic, preventive and curative activity to protect plants against plant pathogens. According to a further aspect of the invention said composition can be used to provide the plants with nutrients. The present composition can be applied to the seeds, fruits, flowers or stems of the plant, the plant foliage, stem cuttings, the complete plant or the roots of the plant or the soil or substrate in which the plant is growing or in which it is intended to grow.

According to an embodiment of the invention, the composition may further comprise Kraft lignin or derivatives thereof and/or organosolv lignin or derivatives thereof.

According to another embodiment of the invention the lignosulfonate in the composition may be replaced by Kraft lignin or derivatives thereof and/or organosolv lignin or derivatives thereof.

In one embodiment of the present invention, the compositions of the present invention are concentrated formulations, such as a soluble concentrate or a water soluble granule, provided to end-users for dilution before field application. The exemplary ranges of concentrations of copper and lignosulfonate provided above are typical of those in a concentrated formulation. In another embodiment, such as dust formulations, the compositions of the present invention are not provided in a concentrated form but in a form that is suitable for field application without dilution. Example 15 provides a table that describes the concentration of the metal ion, lignosulfonate and phosphite ion components of the present invention in a concentrated formulation and an effective amount of each component to be applied per area of crop to be treated (either after dilution with a concentrated formulation or directly with a non-concentrated formulation). In addition, the section below entitled “Pesticide/Biocide Formulation” describes typical concentrations of active ingredients in pesticidal formulations, either before or after dilution.

### Methods of Preventing Formation of a Metal Phosphite Precipitate in an Aqueous Solvent

The present inventors have found that the action of the lignosulfonate is largely preventive, since the formation of a metal phosphite precipitate is irreversible, i.e. it cannot be reversed by the addition of a lignosulfonate afterwards, whereas said formation of a metal phosphite precipitate can easily be reversed by the afterwards addition of minor amounts of chelators like EDTA or citrate. It is therefore a crucial part of the invention that a lignosulfonate is already part of the composition comprising the metal salt(s) and phosphite salt(s) before said composition is mixed with aqueous solvent(s), or, in other embodiments of the invention, that metal salt(s) and phosphite salt(s) are mixed with aqueous solvents that comprise lignosulfonate.

Therefore, the present invention also provides a method that substantially prevents formation of a metal phosphite precipitate in an aqueous solvent comprising steps of:

(i) Mixing at least one lignosulfonate, at least one metal salt, and at least one phosphorus compound to form a powder, wherein a solubilizing amount of a chelator is excluded from said powder;

Optionally, further mixing said powder with at least one compound (e.g., a buffer salt) which in one embodiment provides a pH of ranging from about 4.7 to about 6.0, or in another embodiment provides a pH ranging from about 4.8 to about 5.8, when dissolved in an aqueous solvent.

(ii) Adding the mixed soluble powder into an aqueous solvent (preferably water) to form a solution, wherein the formation of a metal phosphite precipitate is prevented.

Alternatively, the method that substantially prevents formation of a metal phosphite precipitate in an aqueous solvent comprises steps of:

(i) Mixing at least one metal salt, and at least one phosphorus compound to form a powder, wherein a solubilizing amount of a chelator is excluded from said powder;

Optionally, further mixing said powder with at least one compound (e.g., a buffer salt) which in one embodiment provides a pH ranging from about 4.7 to about 6.0, or in another embodiment provides a pH ranging from about 4.8 to about 5.8, when dissolved in an aqueous solvent.

(ii) Adding at least one lignosulfonate into an aqueous solvent (preferably water) to form a pre-prepared lignosulfonate solution; and

(iii) Adding the mixed powder into the lignosulfonate solution to form a final solution, wherein the formation of a metal phosphite precipitate is prevented.

Alternatively again, the method that substantially prevents formation of a metal phosphite precipitate in an aqueous solvent comprises steps of:

(i) Mixing at least one metal salt, and at least one phosphorus compound to form a powder, wherein a solubilizing amount of a chelator is excluded from said powder;

(ii) Adding at least one lignosulfonate and at least one compound (e.g., a buffer salt) which in one embodiment provides a pH ranging from about 4.7 to about 6.0, or in another embodiment provides a pH ranging from about 4.8 to about 5.8, when dissolved in an aqueous solvent into an aqueous solvent (preferably water) to form a pre-prepared lignosulfonate solution with pH range from about 4.7 to about 6.0 in one embodiment, or forms a pre-prepared lignosulfonate solution with a pH range from about 4.8 to about 5.8 in another embodiment; and

(iii) Adding the mixed powder into the lignosulfonate solution to form a final solution, wherein the formation of a metal phosphite precipitate is prevented.

In some embodiments of methods of preventing the formation of metal phosphite precipitate described above, the ratio of metal(s), as ion(s) of the metal salt(s) to lignosulfonate (in weight) in the composition is at least about 1:5 (w/w), about 1:6 (w/w), about 1:7 (w/w), about 1:8 (w/w), about 1:9 (w/w), about 1:10 (w/w), about 1:11 (w/w), about 1:12 (w/w), about 1:13 (w/w), about 1:14 (w/w), about 1:15 (w/w), about 1:16 (w/w), about 1:17 (w/w), about 1:18 (w/w), about 1:19 (w/w), about 1:20 (w/w), about 1:21 (w/w), about 1:22 (w/w), about 1:23 (w/w), about 1:24 (w/w), about 1:25 (w/w), about 1:26 (w/w), about 1:27 (w/w), about 1:28 (w/w), about 1:29 (w/w), about 1:30 (w/w), about 1:31 (w/w), about 1:32 (w/w), about 1:33 (w/w), about 1:34 (w/w), about 1:35 (w/w), about 1:36 (w/w), about 1:37 (w/w), about 1:38 (w/w), about 1:39 (w/w), about 1:40 (w/w), about 1:41 (w/w), about 1:42 (w/w), about 1:43 (w/w), about 1:44 (w/w), about 1:45 (w/w), about 1:46 (w/w), about 1:47 (w/w), about 1:48 (w/w), about 1:49 (w/w), about 1:50 (w/w), about 1:51 (w/w), about 1:52 (w/w), about 1:53 (w/w), about 1:54 (w/w), about 1:55 (w/w), about 1:56 (w/w), about 1:57 (w/w), about 1:58 (w/w), about 1:59 (w/w), about 1:60 (w/w), about 1:61 (w/w), about 1:62 (w/w), about 1:63 (w/w), about 1:64 (w/w), about 1:65 (w/w), about 1:66 (w/w), about 1:67 (w/w), about 1:68 (w/w), about 1:69 (w/w), about 1:70 (w/w), about 1:71 (w/w), about 1:72 (w/w), about 1:73 (w/w), about 1:74 (w/w), about 1:75 (w/w), about 1:76 (w/w), about 1:77 (w/w), about 1:78 (w/w), about 1:79 (w/w), about 1:80 (w/w), about 1:81 (w/w), about 1:82 (w/w), about 1:83 (w/w), about 1:84 (w/w), about 1:85 (w/w), about 1:86 (w/w), about 1:87 (w/w), about 1:88 (w/w), about 1:89 (w/w), about 1:90 (w/w), about 1:91 (w/w), about 1:92 (w/w), about 1:93 (w/w), about 1:94 (w/w), about 1:95 (w/w), about 1:96 (w/w), about 1:97 (w/w), about 1:98 (w/w), about 1:99 (w/w), about 1:100 (w/w), about 1:110 (w/w), about 1:120 (w/w), about 1:130 (w/w), about 1:140 (w/w), about 1:150 (w/w), about 1:160 (w/w), about 1:170 (w/w), about 1:180 (w/w), about 1:190 (w/w), about 1:200 (w/w), about 1:300 (w/w), about 1:400 (w/w), about 1:500 (w/w), about 1:600 (w/w), about 1:700 (w/w), about 1:800 (w/w), about 1:900 (w/w), about 1:1000 (w/w), about 1:2000 (w/w), about 1:3000 (w/w), about 1:4000 (w/w), about 1:5000 (w/w), about 1:6000 (w/w), about 1:7000 (w/w), about 1:8000 (w/w), about 1:9000 (w/w), about 1:10000 (w/w). For example, the ratio of metal(s), as ion(s) of the metal salt(s) (s) to lignosulfonate (in weight) in the composition is between about 1:5 (w/w) and about 1:10000 (w/w), or between about 1:5 (w/w) and about 1:1000 (w/w), or between about 1:5 (w/w) and about 1:500 (w/w), or between 1:5 (w/w) and about 1:200 (w/w), or between about 1:5 (w/w) and about 1:100 (w/w), or between about 1:5 (w/w) and about 1:50 (w/w), or between about 1:5 (w/w) and about 1:20 (w/w), or between about 1:10 (w/w) and about 1:10000 (w/w), or between about 1:10 (w/w) and about 1:1000 (w/w), or between about 1:10 (w/w) and about 1:500 (w/w), or between about 1:10 (w/w) and about 1:200 (w/w), or between about 1:10 (w/w) and about 1:100 (w/w), or between about 1:10 (w/w) and about 1:50 (w/w), or between about 1:10 (w/w) and about 1:20 (w/w).

### Method of Controlling Plant Pathogens

The present invention further provides methods of controlling plant pathogens. The composition can be used to treat agricultural plants or parts thereof and agricultural products, for example as fungicide or bactericide. By preventing the formation of a metal phosphite precipitate, the composition significantly enhances the homogeneous application of metal ion(s), thus enabling reduced input of metal ion(s) without loss of efficacy.

### Formulation of Pesticide/Biocide

Pesticidal/biocidal compositions of the invention comprise mixtures or solutions containing at least one pesticidal combination of the present invention. The pesticidal compounds of the invention can be used alone or in combination. For example, the pesticidal compounds of the present invention are used as a combination of at least one carvacrol pesticidal compound and at least one thymol pesticidal compound.

Pesticidal compositions of the invention may also contain carriers or diluents. A carrier or diluent is an inert material used in making different formulations of pesticidal compounds. The specific carrier used in any pesticidal composition depends on the pest it is meant to eradicate, how the pesticidal composition will be applied (whether in a spray or dust form for example) and where the pesticidal composition will be applied.

Formulation of the pesticidal compound into the pesticidal composition is an important aspect of pesticide manufacturing because of the need to make a pesticidal composition that will both work as intended and will comply with Federal and State regulations. The producers of the pesticidal compound can formulate the compound themselves or can have the pesticidal compound formulated by a secondary entity.

There are a number of different general classes of pesticide formulations, including for example sprays, dusts, granules, and aerosols.

### 1. Spray Formulations

Spray formulations include aqueous solutions, water-soluble powders, emulsifiable concentrates, water miscible liquids/powders (for pesticidal compounds that are soluble in water), water-dispersible powders, and oil solutions. Although sprays are a very popular method of applying pesticides, only a small number of pesticides are sufficiently soluble in water to be formulated into an aqueous solution, water-soluble powder, or water miscible liquid or powder. Therefore, most spray formulations need an organic solvent or a specialized formulation to enable them to be mixed with water for spray application.

The concentration of pesticidal compounds in spray formulations can be at least 1 ppm (0.0001%), at least 10 ppm (0.001%), at least 100 ppm (0.01%), at least 1000 ppm (0.1%), at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, or at least 75%, or at least 80% by weight. For example, in some embodiments, the concentration of pesticidal compounds in the spray formulations of the present invention ranges from 0.25% to 1% by weight. In other embodiments, for example, the concentration of pesticidal compounds in the spray formulations of the present invention ranges from 1% to 5%, from 5% to 10%, from 10% to 20%, from 20% to 30%, from 30% to 40%, from 40% to 50%, from 50% to 60%, from 60% to 70%, or from 70% to 80% by weight.

### 2. Dust Formulations

In a dust formulation, the pesticidal compound is mixed with a solid particulate diluent (preferably one with a size range of 50-100 μm). The dust formulation is then mixed with the air through the aid of a dusting machine. Although dust formulations have historically been the easiest to make and apply, application rates, and pesticidal compound concentrations have to be exceedingly high. Further, even though the amount of pesticidal compound applied is very high, the actual amount of the pesticidal compound that reaches the target is generally low because the dusts are prone to drift.

Dust formulations can be utilized in formulations of the pesticidal compounds of the present invention. Preferred diluents for use in dust formulations are silicon dioxide, zinc oxide, talc, diatomaceous earth, clays, calcium carbonate, wheat flour, and powdered nut hulls.

The concentration of pesticidal compounds in dust foimulations can be at least 1 ppm (0.0001%), at least 10 ppm (0.001%), at least 100 ppm (0.01%), at least 1000 ppm (0.1%), at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, or at least 75%, or at least 80% by weight. For example, in some embodiments, the concentration of pesticidal compounds in the dust formulations of the present invention ranges from 0.25% to 1% by weight. In other embodiments, for example, the concentration of pesticidal compounds in the dust formulations of the present invention ranges from 1% to 5%, from 5% to 10%, from 10% to 20%, from 20% to 30%, from 30% to 40%, from 40% to 50%, from 50% to 60%, from 60% to 70%, or from 70% to 80% by weight.

### 3. Granular Formulations

The pesticidal compounds of the invention can also be formulated into granular formulations. Granules are small pellets (usually 0.3-1.3 mm) of inert carrier (usually clay) mixed with the pesticidal compound to give the desired concentration. Granules can be formulated to allow a rapid release, or an extended release of the pesticidal compound over time. Granular formulations are useful for relatively small scale (garden or houseplant) applications, and in applications where safer handling is desired.

The concentration of pesticidal compounds in granular formulations can be at least 1 ppm (0.0001%), at least 10 ppm (0.001%), at least 100 ppm (0.01%), at least 1000 ppm (0.1%), at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, or at least 75%, or at least 80% by weight. For example, in some embodiments, the concentration of pesticidal compounds in the granular formulations of the present invention ranges from 0.25% to 1% by weight. In other embodiments, for example, the concentration of pesticidal compounds in the granular formulations of the present invention ranges from 1% to 5%, from 5% to 10%, from 10% to 20%, from 20% to 30%, from 30% to 40%, from 40% to 50%, from 50% to 60%, from 60% to 70%, or from 70% to 80% by weight.

### 4. Aerosol Formulation

The pesticidal compounds of the invention can also be formulated into aerosol formulations. In order to use an aerosol formulation, the pesticidal compound must be soluble in a pressurized, volatile, petroleum solvent. Upon application of the aerosol formulation, the solvent evaporates leaving micro-droplets of the pesticidal compound suspended in the air. Aerosol formulations are useful for indoor applications, or small scale outdoor applications.

The concentration of pesticidal compounds in aerosol formulations can be at least 1 ppm, at least 10 ppm, at least 100 ppm, at least 1000 ppm (0.1%), at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, or at least 75%, or at least 80% by weight. For example, in some embodiments, the concentration of pesticidal compounds in the aerosol formulations of the present invention ranges from 0.25% to 1% by weight. In other embodiments, for example, the concentration of pesticidal compounds in the aerosol formulations of the present invention ranges from 1% to 5%, from 5% to 10%, from 10% to 20%, from 20% to 30%, from 30% to 40%, from 40% to 50%, from 50% to 60%, from 60% to 70%, or from 70% to 80% by weight.

### 5. Further Preparation of Pesticidal Composition

The formulated pesticidal composition can either be applied directly or can be diluted further before application. The diluent depends on the specific treatment to be accomplished, and the method of application. For example, a pesticidal composition that is to be applied to trees could be diluted further with water to make it easier and more efficient to spray with known spraying techniques. The formulated pesticidal composition is diluted about 1:10000, about 1:1000, about 1:100, about 1:10, about 1:5, or about 1:2 with water. For example, the pesticidal composition is diluted 1:10 with water.

The following examples are given for purely illustrative and non-limiting purposes of the present invention.

### Examples

### Example 1

Copper phosphite precipitate was formed by combining 0.6 g/l of Cu(OH)₂ and 14.4 g/l of KH₂PO₃ in the presence of 1 g/l of K₂CO₃ to ensure pH 5.5 in demineralised water. This precipitate immediately disappeared upon addition of the chelating agent disodium EDTA (final concentration of 10 mM). The same was observed after addition of the chelating agent trisodium citrate (final concentration of 10 mM). However, addition of 6 g/l sodium lignosulfonate did not reverse the formation of this precipitate, even not after 48 hours of stirring. This example shows that the complexing capacity of sodium lignosulfonate at pH 5.5 is very low and that sodium lignosulfonate does not act in the same way as a chelator.

### Example 2

6 g of sodium lignosulfonate, 0.6 g of Cu(OH)₂, 14.4 g of KH₂PO₃ and 1 g of K₂CO₃ were put together and subsequently mixed with demineralised water to a total volume of 1 litre immediately resulting in a clear solution of pH 5.5. This example shows that the presence of sodium lignosulfonate prevents the formation of copper phosphite precipitate at pH 5.5.

### Example 3

6 g of sodium lignosulfonate was dissolved in 1 litre of demineralised water. Subsequently a mixture of 0.6 g of Cu(OH)₂, 14.4 g of KH₂PO₃ and 1 g of K₂CO₃ was added and mixed, immediately resulting in a clear solution of pH 5.5. This example shows that the presence of sodium lignosulfonate prevents the formation of copper phosphite precipitate at pH 5.5.

### Example 4

Solutions were prepared of: (a) 6 mM copper sulphate (CuSO₄.5H₂O), (b) 6 mM zinc sulphate (ZnSO₄.H₂O), (c) 6 g/l sodium lignosulfonate, (d) 10 mM citric acid, (e) 120 mM potassium dihydrogen phosphite (KH₂PO₃), (f) 120 mM potassium dihydrogen phosphate (KH₂PO₄). Solutions were mixed according to Table 3 and 1 g/l of K₂CO₃ was added to achieve a pH of 5.5. Table 3 shows the effect of sodium lignosulfonate and citric acid on formation of precipitates by mixtures of CuSO₄, KH₂PO₃ or KH₂PO₄ and ZnSO₄, KH₂PO₃ or KH₂PO₄ at pH 5. The results show that sodium lignosulfonate can prevent formation of precipitates of copper sulphate and zinc sulphate with potassium dihydrogen phosphite but not with potassium dihydrogen phosphate. Citric acid, on the contrary, prevented formation of precipitates of copper sulphate and zinc sulphate with both potassium dihydrogen phosphite and potassium dihydrogen phosphate. This example shows that unlike a chelator, the ability of lignosulfonate to prevent precipitates depends on the presence and identity of the anion (i.e., phosphite rather than phosphate) and not just on the metal ion.

TABLE 3

| Mixture | Precipitation |
|---|---|
| Lignosulfonate - CuSO₄ - phosphite | − |
| Lignosulfonate - ZnSO₄ - phosphite | − |
| Lignosulfonate - CuSO₄ - phosphate | + |
| Lignosulfonate - ZnSO₄ - phosphate | + |
| Citric acid - CuSO₄ - phosphite | − |
| Citric acid - ZnSO₄ - phosphite | − |
| Citric acid - CuSO₄ - phosphate | − |
| Citric acid - ZnSO₄ - phosphate | − |

### Example 5

Use of Composition 1 against Black Sigatoka disease of banana, caused by the fungus Mycosphaerella fijiensis.

### Materials and Methods:

### Materials

TABLE 4
Composition 1

| Compound | g/l |
|---|---|
| Sodium lignosulfonate | 143 |
| Cu(OH)₂ | 7.5 |
| ZnSO₄ | 11.3 |
| KH₂PO₃ | 180 |
| K₂CO₃ | 30 |
| pH | 5.5 |

TABLE 5
Fungicides treatments and fungicide dosages applied in the experiment

| Fungicide | | Dosage active ingredient | |
|---|---|---|---|
| Brand name | Active ingredient | (expressed per spray per hectare) | |
| Composition 1 | Copper (Cu²⁺) | 52 | g |
| | Zinc (Zn²⁺) | 57 | g |
| | Phosphite (H₂PO₃⁻) | 1215 | g |
| Pencozeb 75 | Mancozeb | 1500 | g |
| Bravo 720 | Chlorothalonil | 720 | g |
| Baycor 300 | Bitertanol | 150 | g |
| Control | — | 0 | |

TABLE 6
Preparation of spray mixtures for the experiment
(dosage expressed per spray per hectare).

| | Composition 1 | | Pencozeb 75 | | Bravo 720 | | Baycor 300 | |
|---|---|---|---|---|---|---|---|---|
| Oil | 7.5 | l | 7.5 | l | 0 | | 7.5 | l |
| Emulsifier | 75 | ml | 75 | ml | 0 | | 75 | ml |
| Product | 12.4 | l | 2 | kg | 1.0 | l | 300 | ml |
| Water | 0 | | 10.5 | l | 19.0 | l | 12.1 | l |
| Total | 20 | l | 20 | l | 20 | l | 20 | l |

### Methods

The experiment was carried out at Ekona, Cameroon. The experimental design was a randomized complete block design with 5 treatments in 3 replications. Each plot contained 30 banana pseudostems. The treatments were Composition 1 (see Table 4), three commercially available fungicides Pencozeb 75, Bravo 720 and Baycor 300 with the respective active ingredients mancozeb, chlorothalonil and bitertanol and an untreated control. The commercially available fungicides were applied at a rate normal in practice (see Table 5).

Sprays were prepared by mixing the products in banana spray oil (Banole) and emulsifier (Triton X100) for Composition 1, Pencozeb and Baycor or by mixing with water for Bravo. Each product was applied in dosage of 20 l/spray/hectare, using a knapsack manual sprayer and a knapsack engine mist blower. The exact spray mixtures for each product are shown in Table 6. The spray volume and way of application for each commercial fungicide reflects the practice in major industrial banana plantations in Cameroon.

The plots were sprayed at an interval of 8-12 days, depending on the weather conditions. The first application was on July 7 and the last application was on November 23. Due to strong rainfall no sprays were applied between July 27 and September 24. Disease rating was performed weekly during the treatment periods, using the Evolution Status rating.

### Conclusion

Results show that Composition 1 has a higher activity than the commercial fungicides tested. Right after the restart of the applications, the disease rating was clearly lower for the plots treated with Composition 1, indicating a superior rain fastness, or a systemic effect lasting for several weeks or a combination of both these possibilities.

### Example 6

Control of downy mildew (Plasmopara viticola) on young grapevine in the greenhouse by Composition 2 and Composition 3

### Materials

TABLE 7
Composition 2

| compound | g/l |
|---|---|
| Sodium lignosulfonate | 6.0 |
| Cu(OH)₂ | 0.64 |
| KH₂PO₃ | 14.4 |
| K₂CO₃ | 1.0 |
| Surfactant | 1.5 |
| pH | 5.5 |

TABLE 8
Composition 3

| compound | g/l |
|---|---|
| Sodium lignosulfonate | 6.0 |
| ZnSO₄ | 0.10 |
| MnSO₄ | 0.88 |
| KH₂PO₃ | 14.4 |
| K₂CO₃ | 1.0 |
| Surfactant | 1.5 |
| pH | 5.5 |

### Methods

The trial was conducted with young plants of grapevine cultivar Merlot in the greenhouse. Treatments were: Composition 2, Composition 3, Copper hydroxide suspension (Commercial fungicide: Champ Flo) and an untreated control. Each treatment had 10 replicate plants. The experimental set-up was a completely randomized design. Application of the treatments was done with a hand sprayer. The products were applied until the liquids started to run of the leaves. The composition of Composition 2 and 3 is given in Table 7 and 8. The Champ Flo solution was prepared at a concentration of 4.3 g/l.

Treatment of the plants with the fungicides was done at the growth stage of 6-7 leaves per plant.

Inoculation of the plant with the pathogen Plasmopara viticola was performed 10 days after the treatment with the fungicides. The pathogen strain was freshly taken from a natural infestation of grapevine. A suspension of spores in water was prepared at the concentration of 20,000-30,000 spores/ml. The solution was sprayed on the underside of each leaf. After inoculation the plants were wrapped in plastic for 12 hr to create optimal conditions for infection.

Fifteen days after infection the plants were assessed and the area of sporulation of the fungus on the leaf was estimated as percentage of the total leaf area.

The data were arcsine transformed and analyzed with Analysis of Variance and the Newman-Keul test.

The results of the experiment are shown in Table 9. Table 9 shows the effect of different treatments on the leaf area covered by sporulating Plasmopara viticola 15 days after inoculation with the fungus on young plants of grapevine.

TABLE 9

| | % of area leaf area covered | |
|---|---|---|
| Treatment | with sporulating fungus | Significance |
| Champ Flo | 0.0 | a |
| Composition 2 | 1.4 | a |
| Composition 3 | 0.8 | a |
| Untreated control | 65.3 | b |

¹Means with different letters are significantly different (p < 0.05 in Newman - Keul test)

### Conclusion

Both Composition 2 and Composition 3 effectively suppress the development of the downy mildew fungus Plasmopara viticola on young plants of grapevine in greenhouse test. The effectiveness of both compositions is not significantly different from the commercial copper hydroxide product Champ Flo, which contains a 5.7 times higher concentration of copper hydroxide than composition 2.

### Example 7

Control of powdery mildew (Uncinula necator) on young grapevine in the greenhouse by Composition 2 and Composition 3

### Methods

The trial was conducted with young plants (growth stage: 6-7 leaves) of grapevine cultivar Merlot in the greenhouse. Treatments were: Composition 2, Composition 3, and an untreated control. Each treatment had 4 replicate plants. The experimental set-up was a completely randomized design. Application of the treatments was done with a hand sprayer. The products were applied until the liquids started to run of the leaves. The composition of Composition 2 and 3 is given in Table 7 and 8 (see Example 6). The treatments were applied 7, 14, 24 and 34 days after the start of the experiment.

Inoculation of the plant with the pathogen Uncinula necator was performed at the start of the experiment. A suspension of spores in water was prepared at the concentration of 20,000-30,000 spores/ml. The solution was sprayed on each leaf. After inoculation the plants were wrapped in plastic for 12 hr to create optimal conditions for infection.

Forty four days after infection the plants were assessed and the area of infestation the fungus on the leaf was estimated as percentage of the total leaf area.

The data were arcsine transformed and analyzed with Analysis of Variance and the Newman-Keul test.

The results of the experiment are shown in Table 10. Table 10 shows the effect of different treatments on the leaf area covered by Uncinula necator 15 days after inoculation with the fungus on young plants of grapevine.

TABLE 10

| | % of area leaf area covered | |
|---|---|---|
| Treatment | with powdery mildew | Significance |
| Composition 1 | 0.0 | a |
| Composition 2 | 0.0 | a |
| Untreated control | 61.4 | c |

¹Means with different letters are significantly different (p < 0.05 in Newman-Keul test)

### Conclusion

Composition 2 and Composition 3 effectively controlled powdery mildew caused by Uncinula necator over the 40 day period of the trial. No indication of infection with powdery mildew was found on the plants.

### Example 8

Control of late blight (Phytophthora infestans) on potato by Composition 2

### Method

The location of the trial was at Ravenstein, the Netherlands.

The plot size was 5 m×3.75 m with a net plot for assessments of 4 m×2.25 m. The row spacing was 0.75 m. The potato variety was Bintje. The planting date was May 5.

The experiment was set up as a randomized block design in two replications with three treatments: Composition 2 (see Table 7 in Example 6) and the commercially available fungicides Shirlan (active ingredient: Fluazinam) and Dithane NewTec (active ingredient Mancozeb).

The plots were flanked by two rows of untreated potatoes that served as inoculum source.

The products were applied six times, preceded by three applications with 2.0-2.25 kg/ha Dithane NewTec equally applied over the whole trial. The first test application was conducted when first buds of inflorescence were visible. The following five applications were carried out with a 5-7 days interval. The equipment used to carry out the applications was a tractor mounted compressed-air sprayer with a boom of 3.75 m carrying flat fan nozzles of type XR11003VS.

Shirlan (dosage 0.4 l/ha/spray) and Dithane NewTec (dosage 2.25 kg/ha/spray) were diluted with water to a volume equivalent to 300 l/ha, before spraying. Composition 2 was sprayed at 300 l/ha/spray.

Disease progress of Phytophthora infestans was rated once or twice per week. The percentage of the leaf area of the potato plants infected with Phytophthora infestans was visually estimated.

The data were analyzed with Analysis of Variance and the Newman-Keul test.

### Results

The data showing progress of the disease curves for the three treatments are shown in Table 11. Table 11 shows the effect of fungicide treatments on the progress of late blight (Phytophthora infestans) on potato. Data are percentage of leaf surface damaged by late blight. For the ingredients of Composition 2 see Table 7, in example 6.

TABLE 11

| | Date | | | | | | | |
|---|---|---|---|---|---|---|---|---|
| | 02-Jul | 05-Jul | 09-Jul | 12-Jul | 16-Jul | 19-Jul | 23-Jul | 27-Jul |
| shirlan | 4 | 6.5 | 16.5 | 23.5 | 37.5 | 60 | 65 | 60 |
| dithane NewTec | 1.5 | 5 | 9 | 22.5 | 47.5 | 67.5 | 75 | 80 |
| composition 2 | 0.75 | 0.5 | 2.5 | 4 | 6.5 | 7.5 | 12.5 | 17.5 |

The statistical analysis shows that the disease progress in the plots treated with Composition 2 is significantly slower than for the plots treated with Shirlan and Dithane NewTec (p<0.05, Newman Keul test). The disease progress in the plots treated with Shirlan and Dithane NewTec was not significantly different (p=0.35, Newman-Keul test).

### Conclusion

Composition 2 is an effective fungicide against late blight (Phytophthora infestans) on potato. Composition 2 gave a significantly better protection against leaf infection than the commercially available fungicides Shirlan and Dithane NewTec.

In addition, field trials were conducted in potato against late blight using the above spray schedule and applying Composition 4, described below, and the commercial standards, Dithane and Shirlan, as described above. The summer was extremely rainy during the growing season in the Netherlands. Composition 4 outperformed the commercial products, showing good rainfastness even with a standard spray schedule and no supplemental sprays.

### Example 9

The ratio of metal, as ion of the metal salt to lignosulfonate is essential to the performance of the preparation. As Table 12 shows, a ratio of at least about 1:10 (copper:lignosulfonate, w/w) is required to obtain a soluble solution.

TABLE 12

| | Lignosulfonate concentration | | | |
|---|---|---|---|---|
| | 1.5 g/l | 3.0 g/l | 4.5 g/l | 6 g/l |
| Ratio lignosulfonate/copper | 4.2 | 8.6 | 12.9 | 17.1 |
| Soluble product | no | no | Yes | Yes |

Examples 10 to 12 relate to evaluation of Composition 4 (see Table 13) against plant pathogens compared to commercial fungicide/bactericide DuPont™ KOCIDE® 2000.

TABLE 13
Composition 4

| Compound | |
|---|---|
| Lignosulfonate | 26% |
| (Borresperse NA ®) | |
| Cu(OH)₂ | 4.8% |
| KH₂PO3 | 65% |
| Surfactant | 4.2% |
| pH | 5.3 |

DuPont™ KOCIDE® 2000 fungicide/bactericide contains 53.8% copper hydroxide, which is about 10 times the amount of metallic copper in Composition 4 (see Table 13). FIG. 1 shows the appearance of DuPont™ KOCIDE® 2000 and Composition 4.

### Example 10

Control of late blight (Phytophthora infestans) on tomato in the greenhouse by Composition 4 and DuPont™ KOCIDE® 2000 fungicide/bactericide

### Methods

For control of Tomato Late Blight (Phytophthora infestans), an Oomycete “fungal” disease, tomato plants were grown in a greenhouse as previously described. Test rates ranged for 8 lb/A to 0.25 lb/A with a spray volume to simulate an application of 100 gallons per acre (see Table 14). The application was made with an air brush sprayer at 20 psi. The plants received an application on both the upper and lower leaf surfaces and were allowed to air-day for one day.

TABLE 14
Tomato Late Blight, Phytophthora infestans

| | | | % Disease Control | | | |
|---|---|---|---|---|---|---|
| Trt. No. | | Lab dose | Rep 1 | Rep 2 | Rep 3 | Avg |
| | Composition 4 | | | | | |
| 1 | 8 lb/A | 960 mg/100 ml | 95 | 98 | 98 | 97 |
| 2 | 4 lb/A | 480 mg/100 ml | 90 | 90 | 90 | 90 |
| 3 | 2 lb/A | 240 mg/100 ml | 80 | 80 | 80 | 80 |
| 4 | 1 lb/A | 120 mg/100 ml | 50 | 50 | 50 | 50 |
| 5 | 0.50 lb/A | 60 mg/100 ml | 0 | 25 | 0 | 8 |
| 6 | 0.25 lb/A | 30 mg/100 ml | 0 | 0 | 0 | 0 |
| 7 | UTC | n/a | 0 | 0 | 0 | 0 |
| | KOCIDE ® 2000 | | | | | |
| 8 | 8 lb/A | 960 mg/100 ml | 95 | 98 | 95 | 96 |
| 9 | 4 lb/A | 480 mg/100 ml | 90 | 95 | 95 | 93 |
| 10 | 2 lb/A | 240 mg/100 ml | 90 | 90 | 90 | 90 |
| 11 | 1 lb/A | 120 mg/100 ml | 50 | 75 | 75 | 67 |
| 12 | 0.50 lb/A | 60 mg/100 ml | 50 | 50 | 50 | 50 |
| 13 | 0.25 lb/A | 30 mg/100 ml | 25 | 25 | 0 | 17 |
| 14 | UTC | n/a | 0 | 0 | 0 | 0 |

The following day, the plants were inoculated with sporangia from diseased tomato plants maintained in a lighted moist box at 15 C and 100% RH. The spores were diluted in distilled water to achieve a count of 5,000 sporangia/ml after filtering through two layers of cheese cloth. The spore suspension was applied directly to the plants with a hand-held spray bottle. The inoculum load resulted in very heavy disease pressure, far in excess of typical field conditions.

The percentage of disease control was evaluated according to following scale:

Perfect Control
100% control=no disease, perfect control

Good Control
99% control=one or two lesions per plant
98% control=less than five lesions per plant
95% control=roughly five lesions per plant
90% control=roughly 10 lesions per plant, each lesion usually would claim 1% of the leaf surface area

Moderate Control
85% control=moderate control
80% control=moderate control

Poor Control
75% control=slight control
50% control=obviously better than the untreated control, but heavily diseased

No Control
0% control=same as the untreated control

After inoculation, the plants were placed in a dark dew chamber at 15 C and 100% for a period of 24 hrs. After disease infection occurred, the plants were maintained in the lab under fluorescent lights (12 hr photoperiod) for six days. Plants were assessed for disease control by estimating the percent area of healthy leaf tissue.

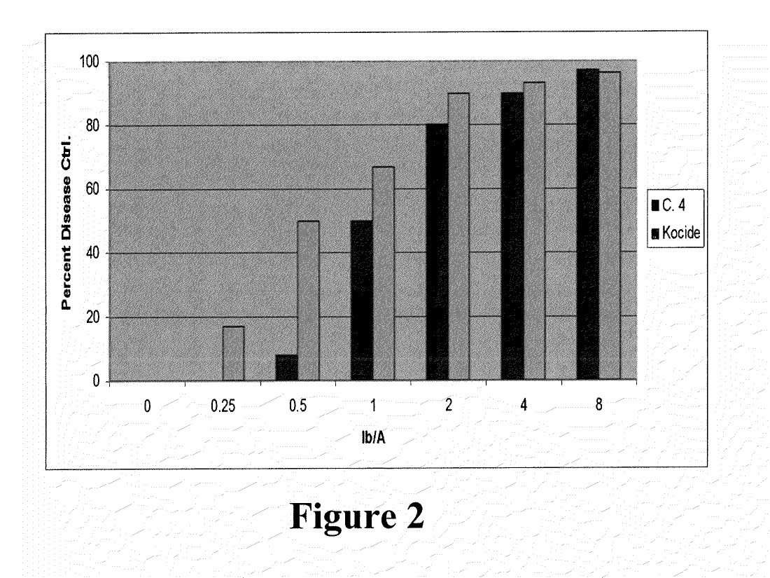

KOCIDE® 2000 performed slightly better than Composition 4 at all tested rates, with the exception of the highest rate of 8 lb/A. Both products provided excellent disease control at rates 2 lb/A and above. Plants treated with KOCIDE® 2000 at 2 lbs/A and above showed a noticeable blue color from the treatment application. No residue was seen with the Composition 4 treatments. The results of the experiment are shown in FIG. 2.

### Conclusion

Both Composition 4 and DuPont™ KOCIDE® 2000 effectively suppress the development of the disease caused by Phytophthora infestans on tomato plants in greenhouse test. The effectiveness of Composition 4 is not significantly different from the commercial copper hydroxide product DuPont™ KOCIDE® 2000, which contains a about 10 times higher concentration of copper hydroxide than composition 4.

### Example 11

Control of downy mildew (Pseudoperonospora cubensis) on cucumber in the greenhouse by Composition 4 and DuPont™ KOCIDE® 2000 fungicide/bactericide

### Methods

For control of Cucumber Downy Mildew (Pseudoperonospora cubensis), an Oomycete “fungal” disease, cucumber plants (Bush Champion Hybrid-Burpee Seed Co.) were grown in a greenhouse to 3 weeks of age with one or two expanded true leaves. Test rates of samples ranged for 4 lb/A to 0.5 lb/A with a spray volume to simulate an application of 100 gallons per acre (see Table 15). The application was made with an artist's air brush sprayer at 20 psi. The plants received an application on both the upper and lower leaf surfaces and were allowed to air-day for one day.

TABLE 15
Cucumber Downy Mildew, Pseduoperonospora cubensis

| | | | % Disease Control | | | |
|---|---|---|---|---|---|---|
| Trt. No. | | Lab dose | Rep 1 | Rep 2 | Rep 3 | Avg |
| | Composition 4 | | | | | |
| 1 | 4 lb/A | 480 mg/100 ml | 95 | 95 | 95 | 95 |
| 2 | 2 lb/A | 240 mg/100 ml | 95 | 95 | 95 | 95 |
| 3 | 1 lb/A | 120 mg/100 ml | 90 | 90 | 90 | 90 |
| 4 | 0.5 lb/A | 60 mg/100 ml | 60 | 60 | 60 | 60 |
| 5 | UTC | n/a | 0 | 0 | 0 | 0 |
| | KOCIDE ® 2000 | | | | | |
| 11 | 4 lb/A | 480 mg/100 ml | 80 | 80 | 80 | 80 |
| 12 | 2 lb/A | 240 mg/100 ml | 80 | 80 | 80 | 80 |
| 13 | 1 lb/A | 120 mg/100 ml | 70 | 60 | 70 | 67 |
| 14 | 0.5 lb/A | 60 mg/100 ml | 50 | 50 | 50 | 50 |
| 15 | UTC | n/a | 0 | 0 | 0 | 0 |

The following day, the plants were inoculated with sporangia from diseased cucumber plants maintained in a lighted moist box at 15 C and 100% RH. The spores were diluted in distilled water to achieve a count of 5,000 sporangia/ml after filtering through two layers of cheese cloth. The spore suspension was applied directly to the upper surface of the leaves with a hand-held spray bottle. The inoculum load resulted in very heavy disease pressure, far in excess of typical field conditions.

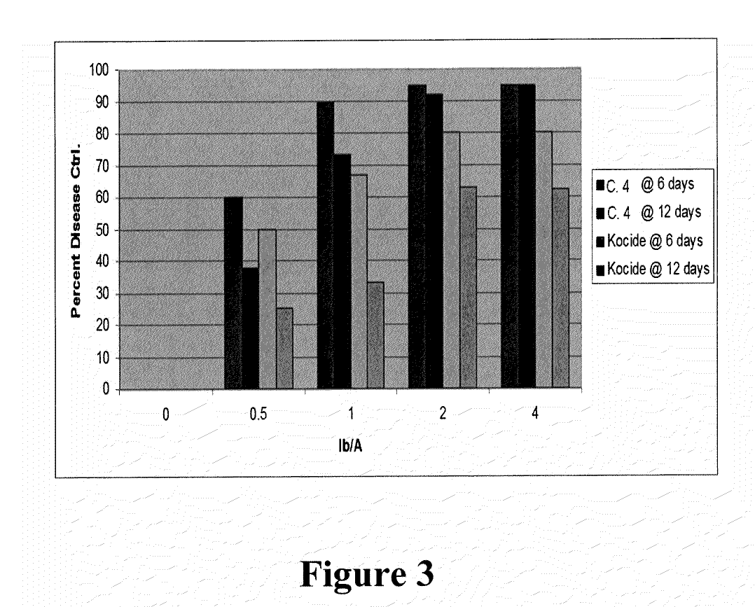

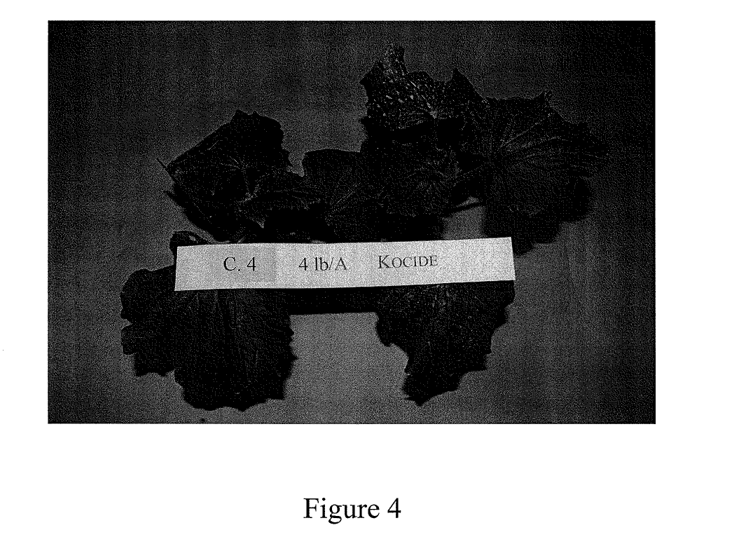

After inoculation, the plants were placed in a dark dew chamber at 15 C and 100% for a period of 24 hrs. After disease infection occurred, the plants were maintained in the lab under fluorescent lights (12 hr photoperiod) for four days. Plants were assessed for disease control by estimating the percent area of healthy leaf tissue. The results of the experiment are shown in FIG. 3, and plants sprayed with Composition 4 and KOCIDE® 2000 are shown in FIG. 4.

The Composition 4 treatments provided superior disease control of Cucumber Downy Mildew than did KOCIDE® 2000 at all rates. High rates of Composition 4 from 1 to 4 lb/A were particularly effective in suppressing Cucumber Downy Mildew.

### Conclusion

Both Composition 4 and DuPont™ KOCIDE® 2000 effectively suppress the development of the disease caused by Pseudoperonospora cubensis on cucumber plants in greenhouse test. Composition 4 is better in controlling downy mildew as compared to commercial copper hydroxide product DuPont™ KOCIDE® 2000, which contains a about 10 times higher concentration of copper hydroxide than Composition 4. The presence of a phosphite salt in Composition 4 slowed the expansion of disease lesions with Oomycete pathogen. Residual activity seemed better with Composition 4. In addition, for Composition 4, no phytotoxicity was observed at field use rates, and no residue was observed on treated leaves (see FIG. 4).

### Example 12

Control of tomato speck (Pseudomonas syringae) on cucumber in the greenhouse by Composition 4 and DuPont™ KOCIDE® 2000 fungicide/bactericide

### Methods

For control of Tomato Speck (Pseudomonas syringae pv. Tomato), a bacterial disease, tomato plants (Big Red Cherry) were grown in a greenhouse to an age of approximately 4 weeks and were 6 to 8 inches in height. The tomato plants were treated with a solution or suspension of the test product (Composition 4 and DuPont™ KOCIDE® 2000) in distilled water at rates to simulate an application of 100 gallons per acre containing a high rate of 8 lb/A, and this rate was reduced by a factor of 2, down to 0.5 lb/A (see Table 16). The application was made with an air brush sprayer at 20 psi. The plants (three replications) received an application on both the upper and lower leaf surfaces. After treatment, the plants were allowed to air dry in the laboratory under fluorescent lamps for one day.

TABLE 16
Tomato Speck, Pseudomonas syringae pv. tomato

| | | | Lesions per leaf | | | |
|---|---|---|---|---|---|---|
| Trt. No. | | Lab dose | Rep 1 | Rep 2 | Rep 3 | Avg |
| | Composition 4 | | | | | |
| 11 | 8 lb/A | 960 mg/100 ml | 10 | 0 | 10 | 7 |
| 12 | 4 | 480 mg/100 ml | 10 | 10 | 10 | 10 |
| 13 | 2 | 240 mg/100 ml | 20 | 50 | 50 | 40 |
| 14 | 1 | 120 mg/100 ml | 50 | 50 | 50 | 50 |
| 15 | 0.5 | 60 mg/100 ml | 100 | 50 | 100 | 83 |
| | KOCIDE ® 2000 | | | | | |
| 16 | 8 lb/A | 960 mg/100 ml | 50 | 50 | 50 | 50 |
| 17 | 4 | 480 mg/100 ml | 100 | 100 | 100 | 100 |
| 18 | 2 | 240 mg/100 ml | 150 | 200 | 200 | 183 |
| 19 | 1 | 120 mg/100 ml | 150 | 200 | 200 | 183 |
| 20 | 0.5 | 60 mg/100 ml | 200 | 200 | 200 | 200 |
| 41 | UTC | n/a | 200 | 200 | 200 | 200 |

The following day, the plants were inoculated a one-day old culture of Pseudomonas syringae pv. tomato. The bacteria were grown in flasks of Nutrient Broth (8 g/L). The broth containing the bacteria was applied directly to the plants with an artist's airbrush sprayer at 40 psi at a concentration of 1×10⁷ CFU per ml. Care was taken not to water soak the plant tissue, but to provide a uniform application to the entire plant. The plants were not water stressed and were in a condition where the stomates should have been open.

After inoculation, the plants were allowed to air-dry under fluorescent lights (12 hr photoperiod). After nine days, the plants were evaluated by estimating the number of bacterial lesions on the leaves.

High rates of KOCIDE®, 4 and 8 lbs/A provided good disease control. All rates of Composition 4 suppressed bacterial lesion development relative to the untreated check plants, and high rates at 4 and 8 lb/A provided excellent disease control.

### Conclusion

Composition 4 appears to have strong activity against bacterial diseases, such as tomato speck caused by Pseudomonas syringae, but so did phosphite salt alone.

### Example 13

Control of leaf blight of wheat (Mycosphaerella graminicola) by composition 4 (Prophetic Example)

Wheat plants are grown in a greenhouse. At the three leaf stage the seedlings are treated with the test solutions, using a hand atomizer. Treatments in the experiments are:
(1) tap water=untreated control, without inoculation of Mycosphaerella graminicola (UTC−INOC);
(2) tap water=untreated control, with inoculation of Mycosphaerella graminicola (UTC+INOC);
(3) composition 4; and
(4) Tilt (commercially used fungicide, active ingredient propiconazole, producer: Syngenta).

Composition 4 is used in a concentration of 6.7 g/l and Tilt is used at a concentration of 3 ml/l. The rates for Composition 4 and Tilt are corresponding to use rates for field application.

Plants are sprayed until the spray liquid runs of the leaves. After this, plants are left to dry for 24 h and inoculated with the pathogen. Quantitative inoculations are made by spraying the seedlings of each tray with 30 ml pycnidiospore suspension of Mycosphaerella graminicola supplemented with two drops of Tween 20 surfactant, using a hand atomizer.

After inoculation, seedlings are placed into an incubation chamber constructed of clear plastic film and fitted with a humidifier to create a water saturated atmosphere. At the end of the 72 h incubation period, plants are left to air dry and are then returned to the greenhouse.

Plant response is determined 24 days after inoculation, by recording the disease severity on the second leaf as a percentage but in terms of 0-9, with terms 0 and 9 indicate immune and 90% of leaf tissue affected, respectively. The experiment is performed with four replications.

### Results

The expected results of the experiment are presented in Table 17.

TABLE 17
leaf blight, Mycosphaerella graminicola

| Trt. | | Disease severity | | | | |
|---|---|---|---|---|---|---|
| No. | treatment | Rep 1 | Rep 2 | Rep 3 | Rep 4 | Average |
| 1 | UTC − INOC | 0 | 0 | 0 | 0 | 0 |
| 2 | UTC + INOC | 9 | 9 | 9 | 9 | 9 |
| 3 | Composition 4 | 1 | 1 | 1 | 1 | 1 |
| 4 | Tilt | 1.5 | 1.5 | 1.5 | 1.5 | 1.5 |

### Conclusion

Composition 4 is expected to have strong activity against fungal diseases of monocotyledones, such as leaf blight of wheat caused by Mycosphaerella graminicola, with even better result than the commercially used fungicide Tilt.

### Example 14

Typical ranges of ratios of metal ions/lignosulfonate/phosphite, by weight

Non-limiting exemplary ranges of ratios of metal ions/lignosulfonate/phosphite are shown below in Table 18:

TABLE 18

| Metal ions (g) | lignosulfonate | HPO₃²⁻ |
|---|---|---|
| 1 | 8.3 | 13 |
| 1 | 10 | 17 |
| 1 | 16 | 27.3 |

### Example 15

Typical ranges of each component of the compositions of the present invention in a concentrated formulation and as applied to a field to be treated are listed in Table 19 and Table 20.

TABLE 19
Composition 5
Soluble Concentrate
(1 liter SC = 1.5 kg)
Application: 400 Liter per ha

| | | % in | | Range of g/ha |
|---|---|---|---|---|
| | Grams per | formulated | % in diluted | applied |
| | liter product | product | product* | per spray** |
| metal ions | 35.6 | 2.4 | 0.027 | 17.8 to 142.4 |
| phosphite*** | 475 | 31.4 | 0.356 | 237.5 to 1900 |
| Lignosulfonate | 330 | 22 | 0.247 | 165 to 1320 |

*on the basis of 3 liter SC dissolved in 400 liter per ha
**on the basis of 0.5 to 4 liter SC per ha
***on the basis of (HPO3)2− ions

Please note: application of ±1.17 kg WG=application of 1 liter SC

TABLE 20
Composition 6
Water Soluble
Granule
Application: 400 Liter per ha)

| | | % in | | Range of g/ha |
|---|---|---|---|---|
| | Grams per | formulated | % in diluted | applied |
| | kg product | product | product* | per spray** |
| metal ions | 30.3 | 3 | 0.023 | 15.15 to 121 |
| phosphite*** | 402 | 40 | 0.3 | 201 to 1608 |
| Lignosulfonate | 281 | 28 | 0.21 | 141 to 1124 |

*on the basis of 3 kg WG dissolved in 400 liter per ha
**on the basis of 0.5 to 4 kg WG per ha
***on the basis of (HPO3)2− ions

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All documents cited are incorporated herein by reference in their entirety for all purposes.

The publications discussed herein are provided solely for their disclosure prior to the filing date of the present application. Nothing herein is to be construed as an admission that the present invention is not entitled to antedate such publication by virtue of prior invention.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

What is claimed is:

1. A composition comprising a soluble combination comprising:
(i) lignosulfonate;
(ii) a metal salt; and
(iii) a phosphorus compound selected from the group consisting of phosphorus acid and spontaneously soluble salts thereof, and mixtures thereof.

2. The composition of claim 1, wherein the composition is soluble in an aqueous solution at pH ranging from about 4.8 to about 5.8.

3. The composition of claim 1, further comprising:
(iv) a buffer salt,
wherein the composition provides a pH ranging from about 4.8 to about 5.8 when dissolved in water.

4. The composition of claim 1, with the proviso that the composition excludes a solubilizing amount of a chelator.

5. The composition of claim 1, wherein the phosphorus compound is phosphorus acid or a phosphite salt.

6. The composition of claim 1, wherein the phosphorus compound is a phosphorus acid.

7. The composition of claim 1, wherein the phosphorus compound is a phosphite salt.

8. The composition of claim 1, wherein the phosphorus compound is a potassium phosphite salt.

9. The composition of claim 1, wherein the metal salt comprises a metal ion selected from the group consisting of copper (II), copper (I), magnesium (II), zinc (II), manganese (II), nickel (II), silver (I), silver (II), titanium (II), titanium (III), and aluminum (III).

10. The composition of claim 9, wherein the metal ion is selected from the group consisting of copper (II), manganese (II), and zinc (II).

11. The composition of claim 10, wherein the metal ion is copper (II).

12. The composition of claim 1,
wherein the metal salt comprises a metal ion selected from the group consisting of copper (II), manganese, and zinc (II); and
wherein the phosphorus compound is one or more phosphate salts.

13. The composition of claim 1, wherein the metal salt comprises copper (II) and the phosphorus compound is a potassium phosphite salt.

14. The composition of claim 1, in the form of a water-soluble concentrate, a water-soluble granule, or a water-soluble powder.

15. The composition of claim 1, wherein the composition is soluble in an aqueous solution at pH ranging from about 5.0 to about 5.5.

16. The composition of claim 1, wherein there is little or no precipitate present in the composition.

17. The composition of claim 1, wherein the ratio of metal, as ions of the metal salt, to lignosulfonate by weight in the composition is at least about 1:10.

18. The composition of claim 1, wherein the ratio of metal, as ions of the metal salt, to lignosulfonate by weight in the composition is between about 1:10 and about 1:100.

19. The composition of claim 1, wherein the concentration of lignosulfonate in the composition is less than about 55% by weight of total composition.

20. The composition of claim 1, wherein the concentration of lignosulfonate in the composition is between about 18% and about 41% by weight of total composition.

21. A method of preventing, reducing and/or eliminating the presence of a pathogen on a plant or on one or more plant parts comprising applying a composition to the plant or to the one or more plant parts, wherein the composition comprises a soluble combination comprising:
(i) lignosulfonate;
(ii) a metal salt; and
(iii) a phosphorus compound selected from the group consisting of phosphorus acid and spontaneously soluble salts thereof, and mixtures thereof.

22. The method of claim 21, wherein the composition is applied as a spray.

23. The method of claim 21, wherein the composition is applied before the pathogen is present on the plant or on the one or more plant parts.

24. The method of claim 21, wherein the composition is applied more than once to the plant or to the one or more plant parts.

25. The method of claim 21, wherein the one or more plant parts is selected from the group consisting of a leaf, a stem, a flower and a fruit.

26. The method of claim 21, wherein a shoot of the plant is sprayed with the composition.

27. The method of claim 21, wherein the plant pathogen is selected from the group consisting of a fungus, a bacteria and a filamentous protist.

28. The method of claim 21, wherein the plant is a banana, a grape, a potato, a tomato, or a cucumber.

29. The method of claim 21, wherein the ratio of metal, as ions of the metal salt, to lignosulfonate by weight in the composition is at least about 1:10.

30. The method of claim 21, wherein the ratio of metal, as ions of the metal salt, to lignosulfonate by weight in the composition is between about 1:10 and about 1:100.

31. A method of making a plant pathogen controlling composition, said method comprising adding the following three components to a liquid: lignosulfonate, a metal salt, and a phosphorus compound; mixing the components or allowing the components to mix so as to produce a solution which is a plant pathogen controlling composition, wherein the phosphorus compound is selected from the group consisting of phosphorus acid and spontaneously soluble salts thereof, and mixtures thereof.

32. The method of claim 31, wherein the lignosulfonate is added to the liquid before the other two components are added.

33. The method of claim 31, wherein the lignosulfonate is mixed in the liquid or allowed to mix in the liquid before the other two components are added to the liquid and the liquid is again mixed or allowed to mix.
